(19) United States
(12) Patent Application Publication
(10) Pub. No.: US 2025/0388481 A1
(43) Pub. Date: Dec. 25, 2025

(54) SYSTEMS AND METHODS FOR BENEFICIATION OF BAUXITE RESIDUE

(71) Applicant: Elementus Minerals, LLC, Fort Lauderdale, FL (US)

(72) Inventors: David BLAKE, Fort Lauderdale, FL (US); Lynnae BLAKE, Fort Lauderdale, FL (US)

(73) Assignee: Elementus Minerals, LLC, Fort Lauderdale, FL (US)

(21) Appl. No.: 19/247,883

(22) Filed: Jun. 24, 2025

Related U.S. Application Data
(60) Provisional application No. 63/663,746, filed on Jun. 25, 2024.

(51) Int. Cl. C01F 7/34; C01B 25/32; C01G 31/00; C22B 3/06; C22B 3/22; C22B 21/00

(52) U.S. Cl. CPC C01F 7/34; C01B 25/32; C01G 31/00; C22B 3/06; C22B 3/22; C22B 21/0015

(57) ABSTRACT

The present disclosure includes systems and methods for beneficiating bauxite residue. The system may comprise a first reaction vessel configured to receive a first stream comprising vanadic acid (H₃VO₄); and a second stream comprising an alkaline solution. The system may comprise a third stream passed from the first reaction vessel. The third stream may comprise a metavanadate salt. The system may comprise a filter configured to separate a vanadium-rich stream from the third stream. The system may comprise a second reaction vessel configured to receive a fourth stream comprising scandium carbonate (Sc₂(CO₃)₃) and a fifth stream comprising an organic acid.

### CROSS-REFERENCE TO RELATED APPLICATIONS

This application claims priority to U.S. Provisional Application No. 63/663,746, filed on Jun. 25, 2024, which is hereby incorporated by reference in its entirety.

### FIELD OF DISCLOSURE

The present disclosure relates to systems and methods for beneficiating and/or recovering one or more elements from bauxite residue. Some aspects of the present disclosure relate to systems and methods for the beneficiating and/or recovering vanadium, chromium, iron, aluminum, calcium, silicon, titanium, or a combination thereof, from bauxite residue.

### INTRODUCTION

Bauxite residue is a by-product formed during alumina production from bauxite ore. For example, bauxite residue may be formed when alumina is produced using the Bayer process. Bauxite residue can vary in composition, and may include iron, aluminum, titanium, calcium, silicon, and sodium. Depending on the location and composition of source bauxite, the resulting bauxite residue can vary in water content, pH, density, and viscosity. Bauxite residue may also be referred to as red mud, bauxite tailings, or alumina refining residues.

Most bauxite residue remains stored at the site of alumina production due to a lack of commercially viable systems and methods for repurposing the bauxite residue. Storage and handling of bauxite residue can result in significant costs. Accordingly, there exists a need for systems and methods for beneficiating bauxite residue. There also exists a need for systems and methods for recovering materials of value from bauxite residue.

### SUMMARY

The present disclosure includes systems for beneficiating bauxite residue. For example, the system may comprise a first reaction vessel configured to receive a first stream comprising vanadic acid (H₃VO₄) and a second stream comprising an alkaline solution; a third stream passed from the first reaction vessel, wherein the third stream comprises a metavanadate salt; a filter configured to separate a vanadium-rich stream from the third stream; a second reaction vessel configured to receive a fourth stream comprising scandium carbonate (Sc₂(CO₃)₃) and a fifth stream comprising an organic acid; a fifth stream passed from the second reaction vessel, wherein the fifth stream comprises at least approximately 0.1 wt. % of a salt comprising scandium, based on the total weight of the fifth stream. The first stream may be derived from bauxite residue, and the fourth stream may be derived from bauxite residue. The fifth stream may comprise at least approximately 1.0 wt. % of the salt comprising scandium.

In some aspects, the vanadium-rich stream may comprise at least approximately 95 wt. % of the metavanadate salt, based on the total weight of solids in the vanadium-rich stream. The metavanadate salt may include ammonium metavanadate (NH₄VO₃). The salt may comprise scandium includes scandium oxalate (Sc₂(C₂O₄)₃). The filter may be further configured to separate a sixth stream from the third stream, wherein the sixth stream comprises a chromate salt. The system may further comprise a third reaction vessel configured to receive the sixth stream and a seventh stream comprising a bisulfite salt; and an eighth stream comprising chromium oxide (Cr₂O₃) passed from the third reaction vessel.

In some aspects, the filter may be a first filter, and the system may further comprise a second filter configured to separate a titanium/calcium/silicon-rich stream and the fourth stream from a sixth stream, wherein the sixth stream comprises scandium carbonate (Sc₂(CO₃)₃), calcium carbonate (CaCO₃), one or more calcium aluminosilicates, and titanium dioxide (TiO₂).

The system may comprise a first reaction vessel configured to receive a first stream and an alkaline solution, wherein the first stream is derived from bauxite residue. The system may include a first filter configured to separate a leach residue and a leach filtrate from a leachate passed from the first reaction vessel. The system may include a second reaction vessel configured to roast a mixture including the leach residue, wherein roasting the mixture including the leach residue generates a metallized residue. The system may include a third reaction vessel configured to receive a second stream and oxalic acid, wherein the second stream comprises at least a portion of the metallized residue. The third reaction vessel may be configured to receive a third stream passed from the third reaction vessel, wherein the third stream comprises: at least approximately 1.0 wt. % scandium oxalate (Sc₂(C₂O₄)₃), at least approximately 1.0 wt. % zirconyl oxalate (ZrOC₂O₄), or both, based on the total weight of the third stream. Roasting the mixture including the leach residue may also generate roasting off-gas, and the system may further comprise a fourth reaction vessel configured to receive the roasting off-gas and a fourth stream comprising at least a portion of the leach filtrate. The system may further comprise a second filter configured to separate an aluminum-rich stream and a precipitate filtrate from an aluminum slurry passed from the fourth reaction vessel, wherein the aluminum-rich stream comprises at least 95 wt. % of an aluminum salt, based on the total weight of solids in the aluminum slurry. The system may further comprise an evaporator configured to remove water from a fifth stream, which may include at least a portion of the precipitate filtrate.

In some aspects, the system may further comprise a fourth reaction vessel configured to receive a solution comprising calcium hydroxide and fourth stream comprising at least a portion of the leach filtrate. The system may include a second filter configured to separate a phosphorous-containing compound and a purified filtrate from a fifth stream passed from the fourth reaction vessel. The system may further comprise a fifth reaction vessel configured to receive a solution comprising a hydroxide salt and fifth stream comprising at least a portion of the purified filtrate. The system may further include a third filter configured to separate a vanadium-rich stream from a sixth stream passed from the fifth reaction vessel. The vanadium-rich stream may include at least 95 wt. % of a compound comprising vanadium, based on the total weight of the vanadium-rich stream.

The present disclosure also includes methods for beneficiating bauxite residue. For example, the method may comprise: introducing bauxite residue and sodium carbonate (Na₂CO₃) to a dryer; blending and drying the sodium carbonate (Na₂CO₃) and bauxite residue in the dryer, thereby forming dried bauxite residue; introducing an alkaline solution and a stream including the dried bauxite residue to a first reaction vessel, and forming a leachate within the first reaction vessel; separating a leach residue and a leach filtrate from the leachate; precipitating a phosphorous-containing compound, a vanadium-containing compound, or both, out of the leach filtrate, thereby forming a purified leachate; and precipitating a salt, out of the purified leachate, wherein the salt comprises aluminum. The phosphorous-containing compound may be a hydroxyphosphate salt, and the vanadium-containing compound may be a metavanadate salt. The method may further comprise roasting the leach residue, to form a roasted leach residue and roasting off-gas; magnetically separating iron-containing species from the roasted leach residue, thereby forming a slag residue; introducing the slag residue the roasting-off gas to a second reaction vessel, and forming a precipitate in the second reaction vessel. In some aspects, the stream including the dried bauxite residue may be a first stream. In these aspects, the method may further comprise: introducing oxalic acid and a second stream to a second reaction vessel, wherein the second stream is derived from the leach residue; and passing a third stream from the second reaction vessel, wherein the third stream comprises scandium oxalate (Sc₂(C₂O₄)₃) and zirconyl oxalate (ZrOC₂O₄).

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments. Any features of an embodiment or example described herein (e.g., composition, formulation, method, etc.) may be combined with any other embodiment or example, and all such combinations are encompassed by the present disclosure. Moreover, the described systems and methods are neither limited to any single aspect nor embodiment thereof, nor to any combinations or permutations of such aspects and embodiments. For the sake of brevity, certain permutations and combinations are not discussed and/or illustrated separately herein.

FIG. 1 is a schematic representation of an exemplary process flow for beneficiating bauxite residue, according to aspects of the present disclosure;

FIG. 2 is a schematic representation of an exemplary process flow for beneficiating bauxite residue, according to aspects of the present disclosure;

FIGS. 3-13 are schematic representations of portions of an exemplary system for beneficiating bauxite residue, according to aspects of the present disclosure;

FIGS. 14A-14F depict tables detailing physical properties of exemplary streams, according to aspects of the present disclosure; and

FIGS. 15A-15M depict tables detailing material compositions of exemplary streams, according to aspects of the present disclosure.

### DETAILED DESCRIPTION

Unless defined otherwise, all technical and scientific terms used herein have the same meaning as is commonly understood by one of ordinary skill in the art to which this disclosure belongs. Although any suitable methods and materials (e.g., similar or equivalent to those described herein) can be used in the practice or testing of the present disclosure, particular example methods are now described. All publications mentioned are hereby incorporated by reference.

As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” For the terms “for example” and “such as,” and grammatical equivalences thereof, the phrase “and without limitation” is understood to follow unless explicitly stated otherwise.

As used herein, the term “approximately” is meant to account for variations due to experimental error. When applied to numeric values, the term “approximately” may indicate a variation of +/−5% from the disclosed numeric value, unless a different variation is specified. As used herein, the singular forms “a,” “an,” and “the” include plural referents unless the context clearly dictates otherwise. Further, all ranges are understood to be inclusive of endpoints, e.g., from 1 meter to 5 meters would include lengths of 1 meter, 5 meters, and all lengths between 1 meter and 5 meters.

It should be noted that all numeric values disclosed or claimed herein (including all disclosed values, limits, and ranges) may have a variation of +/−5% from the disclosed numeric value unless a different variation is specified.

In describing embodiments of the present disclosure, part names are intended to be descriptive and not limiting. For example, methods and systems described herein may include streams comprising a combination of substances. For clarity, a stream may be named according to one or more components of the stream. In addition or alternatively, streams may be named according to their relative position within a process or system. The name of a particular stream or component of a method or system described herein should not be considered limiting on the composition or properties of the named stream or component. For example, “ammonium metavanadate stream 3213” may comprise ammonium metavanadate, and/or any number of other species, as described herein. As another example “purified aluminum leachate 3201,” has a composition as described herein, and is not necessarily limited to compositions having undergone a purification process, combinations including aluminum, or leachates from a leaching operation.

Bauxite residue may comprise aluminum, arsenic, calcium, cerium, chromium, iron, lanthanum, lead, magnesium, manganese, nickel, neodymium, niobium, scandium, silicon, strontium, thorium, titanium, vanadium, yttrium, and/or zirconium. For example, bauxite residue may comprise aluminum hydroxide oxide (AlO(OH)), anatase (TiO₂), arsenic trioxide (As₂O₃), boehmite (α-Al₂O₃·H₂O), calcite (CaCO₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cancrinite (Na₆Ca₂[(CO₃)₂|Al₆Si₆O₂₄]·2H₂O), cerium oxide (CeO₂), chromium oxide (Cr₂O₃), diaspore (β-Al₂O₃·H₂O), ferric oxide (Fe₂O₃), ferric oxyhydroxide (FeO(OH)), ferryhydrite (Fe₂O₃·0.5H₂O), gibbsite (α-Al₂O₃·3H₂O), goethite (FeO(OH)), halloysite (Al₂Si₂O₅(OH)₄), hematite (α-Fe₂O₃), hydroxyapatite (Ca₅(PO₄)₃OH), hydroxylapatite (Ca₅(PO₄)₃OH), ilmenite (FeO·TiO₂), kaolinite (Al₂Si₂O₅ (OH)₄), lanthanum (III) oxide (La₂O₃), lead (II) oxide (PbO), maghemite (γ-Fe₂O₃), magnesium hydroxide (Mg(OH)₂), magnetite (Fe₃O₄), manganese (II) hydroxide (Mn(OH)₂), monazite ((Ce,La,Pr,Nd,Th,Y)PO₄), neodymium (III) oxide (Nd₂O₃), nickel (II) oxide (NiO), niobium pentoxide (Nb₂O₅), perovskite (CaTiO₃), portlandite (Ca(OH)₂), potassium oxide (K₂O), pyrite (FeS₂), quartz (SiO₂), rutile (TiO₂), scandium oxide (Sc₂O₃), silicon dioxide (SiO₂), sillimanite (Al₂SiO₅), sodalite (Na₈(Al₆Si₆O₂₄)Cl₂), sodium aluminate (NaAlO₂), sodium metasilicate (Na₂SiO₃), strontium oxide (SrO), synchysite-(Ce) (CaCe(CO₃)₂F), thorium dioxide (ThO₂), titanium dioxide (TiO₂), vanadium pentoxide (V₂O₅), xenotime (YPO₄), yttrium (III) oxide (Y₂O₃), zirconium dioxide (ZrO₂), or a combination thereof.

Bauxite residue may comprise solid and/or aqueous phases. In some embodiments, bauxite residue may comprise approximately 15-45 weight percent (wt. %) water, based on the total weight of the bauxite residue. Bauxite residue comprising 15-30 wt. % water may be stored in a dry storage location, and bauxite residue comprising 30-45 wt. % water may be stored in retention ponds. The systems and methods of the present disclosure may be used with bauxite residue comprising any water content, such as, for example, bauxite residue from dry storage and/or bauxite residue from a retention pond. As described herein, the steps of a process for beneficiating bauxite residue may be modified, adjusted, and/or reordered depending on the composition of the bauxite residue being beneficiated.

In some embodiments, a process for beneficiating bauxite residue includes improving the recoverability of one or more elements in bauxite residue. A system for beneficiating bauxite residue may be configured to facilitate a process for beneficiating bauxite residue and/or improve the recoverability of one or more elements in bauxite residue.

In some embodiments, a process for beneficiating bauxite residue includes improving the recoverability of vanadium, and/or recovering vanadium. For example, a process for beneficiating bauxite residue may generate one or more compounds including vanadium that are suitable for storage, transport, and/or use. By way of non-limiting example, vanadium compounds generated by methods and systems of the present disclosure may include ammonium metavanadate ((NH₄)₃VO₃).

In some embodiments, a process for beneficiating bauxite residue includes improving the recoverability of chromium, and/or recovering chromium. For example, a process for beneficiating bauxite residue may generate one or more compounds including chromium that are suitable for storage, transport, and/or use. By way of non-limiting example, chromium compounds generated by methods and systems of the present disclosure may include chromium oxide (Cr₂O₃).

In some embodiments, a process for beneficiating bauxite residue includes improving the recoverability of aluminum, and/or recovering aluminum. For example, a process for beneficiating bauxite residue may generate one or more compounds including aluminum that are suitable for storage, transport, and/or use. By way of non-limiting example, aluminum compounds generated by methods and systems of the present disclosure may include aluminum hydroxide (Al(OH)₃).

In some embodiments, a process for beneficiating bauxite residue includes improving the recoverability of iron, and/or recovering iron. For example, a process for beneficiating bauxite residue may generate one or more compounds including iron that are suitable for storage, transport, and/or use. By way of non-limiting example, iron compounds generated by methods and systems of the present disclosure may include elemental iron, such as, for example, pig iron.

In some embodiments, a process for beneficiating bauxite residue includes improving the recoverability of calcium, and/or recovering calcium. For example, a process for beneficiating bauxite residue may generate one or more compounds including calcium that are suitable for storage, transport, and/or use. By way of non-limiting example, calcium compounds generated by methods and systems of the present disclosure may include calcium carbonate (CaCO₃).

In some embodiments, a process for beneficiating bauxite residue includes improving the recoverability of silicon, and/or recovering silicon. For example, a process for beneficiating bauxite residue may generate one or more compounds including silicon that are suitable for storage, transport, and/or use. By way of non-limiting example, silicon compounds generated by methods and systems of the present disclosure may include calcium aluminosilicate (Ca₂Al₂SiO₇).

In some embodiments, a process for beneficiating bauxite residue includes improving the recoverability of titanium, and/or recovering titanium. For example, a process for beneficiating bauxite residue may generate one or more compounds including titanium that are suitable for storage, transport, and/or use. By way of non-limiting example, titanium compounds generated by methods and systems of the present disclosure may include titanium dioxide (TiO₂).

In some embodiments, a process for beneficiating bauxite residue includes improving the recoverability of scandium, and/or recovering scandium. For example, a process for beneficiating bauxite residue may generate one or more compounds including scandium that are suitable for storage, transport, and/or use. By way of non-limiting example, scandium compounds generated by methods and systems of the present disclosure may include scandium oxalate (Sc₂(C₂O₄)₃).

In some embodiments, a process for beneficiating bauxite residue includes improving the recoverability of zirconium, and/or recovering zirconium. For example, a process for beneficiating bauxite residue may generate one or more compounds including zirconium that are suitable for storage, transport, and/or use. By way of non-limiting example, zirconium compounds generated by methods and systems of the present disclosure may include zirconyl oxalate (ZrOC₂O₄).

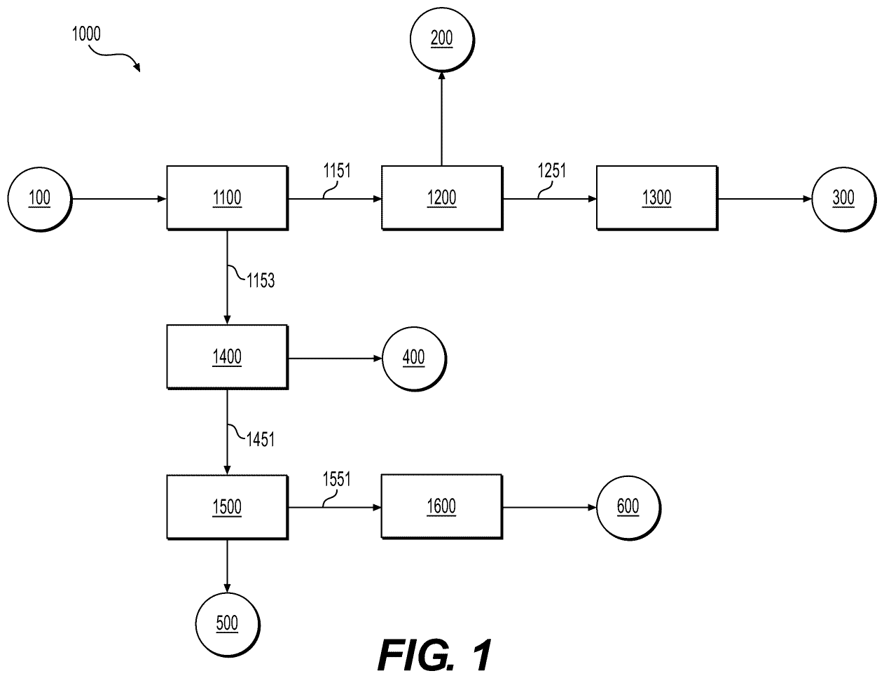

Referring to FIG. 1, a process 1000 for beneficiating bauxite residue 100 may include the generation of a vanadium-rich stream 200, an aluminum-rich stream 300, an iron-rich stream 400, a calcium/silicon/titanium-rich stream 500, and/or a scandium-rich stream 600. The vanadium-rich stream 200 may include one or more vanadium species that have improved availability, compared to the vanadium species present in bauxite residue 100. For example, vanadium-rich stream 200 may comprise ammonium metavanadate ((NH₄)₃VO₃). Vanadium-rich stream 200 may comprise greater than or equal to approximately 95 wt. % vanadium compounds, based on the total weight of solids in vanadium-rich stream 200, such as, for example, approximately 95 wt. % to approximately 100 wt. %, greater than or equal to approximately 99 wt. %, approximately 99 wt. % to approximately 100 wt. %, greater than or equal to approximately 99.9 wt. %, or approximately 100 wt. % vanadium compounds (e.g., ammonium metavanadate ((NH₄)₃VO₃)). In some embodiments, vanadium-rich stream 200 may include solid and aqueous phases. The aqueous phase of vanadium-rich stream 200 may include vanadic acid (H₃VO₄), sodium hydroxide (NaOH), sodium chromate (Na₂CrO₄), or a combination thereof.

The aluminum-rich stream 300 may include one or more aluminum species that have improved availability, compared to the aluminum species present in bauxite residue 100. For example, aluminum-rich stream 300 may comprise aluminum hydroxide (Al(OH)₃). Aluminum-rich stream 300 may comprise greater than or equal to approximately 95 wt. % aluminum compounds, based on the total weight of solids in aluminum-rich stream 300, such as, for example, approximately 95 wt. % to approximately 100 wt. %, greater than or equal to approximately 99 wt. %, approximately 99 wt. % to approximately 100 wt. %, greater than or equal to approximately 99.9 wt. %, or approximately 100 wt. % aluminum compounds (e.g., aluminum hydroxide (Al(OH)₃)). In some embodiments, aluminum-rich stream 300 may include solid and aqueous phases. The aqueous phase of aluminum-rich stream 300 may include oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium chromate (Na₂CrO₄), ammonium hydroxide (NH₄OH), scandium oxalate (Sc₂(C₂O₄)₃), zirconyl oxalate (ZrOC₂O₄), or a combination thereof. In addition to one or more aluminum compounds (e.g., Al(OH)₃), aluminum-rich stream 300 may include vanadium pentoxide (V₂O₅).

The iron-rich stream 400 may include one or more iron species that have improved availability, compared to the iron species present in bauxite residue 100. For example, iron-rich stream 400 may comprise iron (Fe). Iron-rich stream 400 may comprise greater than or equal to approximately 90 wt. % iron, based on the total weight of iron-rich stream 400, such as, for example, approximately 90 wt. % to approximately 100 wt. %, greater than or equal to approximately 92 wt. %, greater than or equal to approximately 95 wt. %, greater than or equal to approximately 97 wt. %, greater than or equal to approximately 99 wt. %, approximately 92 wt. % to approximately 100 wt. %, or approximately 95 wt. % to approximately 100 wt. %. In some embodiments, iron-rich stream 400 may include carbon (C), calcium aluminosilicate (Ca₂Al₂SiO₇), calcium orthosilicate (Ca₂SiO₄), calcium hydroxyphosphate (Ca₅(OH)(PO₄)₃), calcium sulfate dihydrate (CaSO₄·2H₂O), calcium oxide (CaO), iron phosphide (FeP), potassium oxide (K₂O), lanthanum oxide (La₂O₃), manganese oxide (MnO), sodium carbonate (Na₂CO₃), neodymium oxide (Nd₂O₃), arsenic trioxide (As₂O₃), calcium hydroxide (Ca(OH)₂), cerium oxide (CeO), magnesium oxide (MgO), niobium pentoxide (Nb₂O₅), nickel (II) oxide (NiO), lead (II) oxide (PbO), scandium oxide (Sc₂O₃), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof.

The calcium/silicon/titanium-rich stream 500 may include one or more species of calcium that have improved availability, compared to the calcium species present in bauxite residue 100. In addition or alternatively, calcium/silicon/titanium-rich stream 500 may include one or more species of silicon that have improved availability, compared to the silicon species present in bauxite residue 100. In addition or alternatively, calcium/silicon/titanium-rich stream 500 may include one or more species of titanium that have improved availability, compared to titanium species present in bauxite residue 100. For example, calcium/silicon/titanium-rich stream 500 may comprise calcium aluminosilicate (Ca₂Al₂SiO₇), calcium carbonate (CaCO₃), titanium dioxide (TiO₂), or a combination thereof.

Calcium/silicon/titanium-rich stream 500 may comprise greater than or equal to approximately 5 wt. % calcium aluminosilicate (Ca₂Al₂SiO₇), based on the total weight of solids within calcium/silicon/titanium-rich stream 500, such as, for example, approximately 5 wt. % to approximately 25 wt. %, approximately 10 wt. % to approximately 25 wt. %, approximately 15 wt. % to approximately 25 wt. %, approximately 10 wt. % to approximately 20 wt. %, approximately 15 wt. % to approximately 20 wt. %, approximately 16 wt. %, greater than or equal to approximately 10 wt. %, or greater than or equal to approximately 15 wt. %.

Calcium/silicon/titanium-rich stream 500 may comprise greater than or equal to approximately 15 wt. % calcium carbonate (CaCO₃), based on the total weight of solids within calcium/silicon/titanium-rich stream 500, such as, for example, greater than or equal to approximately 20 wt. %, greater than or equal to approximately 25 wt. %, greater than or equal to approximately 30 wt. %, greater than or equal to approximately 35 wt. %, approximately 15 wt. % to approximately 50 wt. %, approximately 20 wt. % to approximately 50 wt. %, approximately 25 wt. % to approximately 50 wt. %, approximately 30 wt. % to approximately 50 wt. %, approximately 5 wt. % to approximately 40 wt. %, approximately 10 wt. % to approximately 35 wt. %, approximately 25 wt. % to approximately 45 wt. %, approximately 30 wt. % to approximately 40 wt. %, or approximately 35 wt. %.

Calcium/silicon/titanium-rich stream 500 may comprise greater than or equal to approximately 5 wt. % titanium dioxide (TiO₂), based on the total weight of solids within calcium/silicon/titanium-rich stream 500, such as, for example, approximately 5 wt. % to approximately 25 wt. %, approximately 10 wt. % to approximately 25 wt. %, approximately 15 wt. % to approximately 25 wt. %, approximately 10 wt. % to approximately 20 wt. %, approximately 15 wt. % to approximately 20 wt. %, approximately 19 wt. %, greater than or equal to approximately 10 wt. %, or greater than or equal to approximately 15 wt. %.

In some embodiments, calcium/silicon/titanium-rich stream 500 may include a solid phase and an aqueous phase. The solid phase of calcium/silicon/titanium-rich stream 500 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium magnesium carbonate (CaMg(CO₃)₂), calcium carbonate (CaCO₃), manganese carbonate (MnCO₃), carbon (C), cerium oxide (CeO₂), iron (Fe), iron phosphide (FeP), lanthanum (III) oxide (La₂O₃), lead (II) oxide (PbO), manganese oxide (MnO), neodymium (III) oxide (Nd₂O₃), nickel (II) oxide (NiO), niobium pentoxide (Nb₂O₅), potassium oxide (K₂O), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of calcium/silicon/titanium-rich stream 500 may comprise oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof.

The scandium-rich stream 600 may include one or more species of scandium that have improved availability, compared to the scandium species present in bauxite residue 100. For example, scandium-rich stream 600 may comprise scandium oxalate (Sc₂(C₂O₄)₃). In some embodiments, scandium-rich stream 600 is an aqueous solution that also comprises zirconyl oxalate (ZrOC₂O₄). Scandium-rich stream 600 may comprise greater than or equal to approximately 0.5 wt. % scandium oxalate (Sc₂(C₂O₄)₃), based on the total weight of scandium-rich stream 600, such as, for example, greater than or equal to approximately 0.5 wt. %, greater than or equal to approximately 1.0 wt. %, greater than or equal to approximately 1.2 wt. %, greater than or equal to approximately 1.5 wt. %, or approximately 0.5 wt. % to approximately 2.5 wt. %. Scandium-rich stream 600 may comprise greater than or equal to approximately 0.5 wt. % zirconyl oxalate (ZrOC₂O₄), based on the total weight of scandium-rich stream 600, such as, for example, greater than or equal to approximately 1.0 wt. %, greater than or equal to approximately 1.5 wt. %, greater than or equal to approximately 1.8 wt. %, greater than or equal to approximately 2.0 wt. %, or approximately 0.5 wt. % to approximately 4.0 wt. %.

Still referring to FIG. 1, process 1000 may include bauxite residue processing 1100. Bauxite residue processing 1100 may include mechanically and/or chemically breaking down the bauxite residue 100 to increase the availability of constituent elements. For example, bauxite residue processing 1100 may include drying the bauxite residue 100, blending the bauxite residue 100 with sodium carbonate, pelleting the blended bauxite residue 100, roasting the pelletized bauxite residue 100, grinding the roasted pellets, and/or leaching the roasted, pelletized, ground bauxite residue 100. Bauxite residue processing 1100 may generate an aluminum leaching filtrate 1151 and an aluminum leaching residue 1153.

In some embodiments, process 1000 includes vanadium and phosphate separation 1200. For example, the aluminum leaching filtrate 1151 from bauxite residue processing 1110 may be precipitated, ion-exchanged, and/or filtered to generate the vanadium-rich stream 200. An aluminum slurry 1251 may also be generated during vanadium and phosphate separation 1200. In some embodiments, process 1000 includes aluminum separation 1300. For example, the aluminum slurry 1251 may be filtered to generate an aluminum-rich stream 300.

In some embodiments, process 1000 includes iron separation 1400. For example, aluminum leaching residue 1153 may be further processed (e.g., briquetted, roasted, and/or ground). Iron from the processed aluminum leaching residue 1153 may be magnetically separated to generate iron-rich stream 400. The remaining processed residue 1153 may form a slag residue 1451.

In some embodiments, process 1000 includes calcium/silicon/titanium separation 1500. For example, components of slag residue 1451 may be carbonized and/or filtered. The residue from filtered carbonized slag residue 1451 may be extracted and/or further processed to generate a calcium/silicon/titanium-rich stream 500.

The filtrate from carbonized slag residue 1451 (e.g., scandium carbonization filtrate 1551) may be further processed to recover scandium. For example, process 1000 may include scandium separation 1600. Scandium separation 1600 may include ion-exchanging the scandium carbonization filtrate 1551 to generate a scandium-rich stream 600.

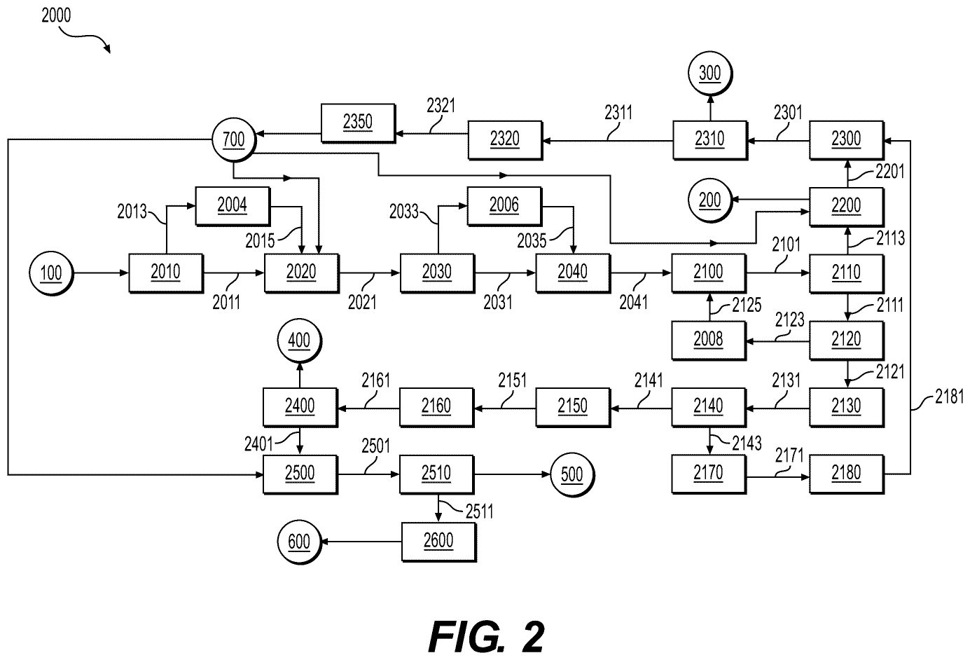

Referring to FIG. 2, a process 2000 for beneficiating bauxite residue 100 may include the generation of a vanadium-rich stream 200, an aluminum-rich stream 300, an iron-rich stream 400, a calcium/silicon/titanium-rich stream 500, and/or a scandium-rich stream 600.

Process 2000 may comprise bauxite residue drying 2010. In some embodiments, bauxite residue drying 2010 may include mixing and/or blending bauxite residue 100 with sodium carbonate (Na₂CO₃) (e.g., regenerated sodium carbonate 700). For example, sodium carbonate (Na₂CO₃) may be added in an amount equivalent to approximately 15% to approximately 35% of the weight of bauxite residue 100. In some embodiments, sodium carbonate (Na₂CO₃) may be added in an amount equivalent to approximately 25% of the weight of bauxite residue 100. The blended bauxite residue 100 and sodium carbonate mixture may be dried. In some embodiments, the bauxite residue and sodium carbonate may be blended while being dried (e.g., utilizing a paddle dryer). During bauxite residue drying 2010, liquid water may be converted to gaseous water (e.g., water vapor and/or steam).

A dried bauxite residue 2011 may be generated during bauxite residue drying 2010. Bauxite residue drying off-gas 2013 may also be generated during bauxite residue drying 2010. Dried bauxite residue 2011 may include a solid phase, an aqueous phase, or both. The water content of dried bauxite residue 2011 may be approximately one-third of the water content of bauxite residue 100. For example, the water content of dried bauxite residue 2011 may be approximately 25% to approximately 75% of the water content of bauxite residue 100.

The solid phase of dried bauxite residue 2011 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of dried bauxite residue 2011 may comprise water (H₂O), oxalic acid (C₂H₂O₄), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), or a combination thereof.

Bauxite residue drying off-gas 2013 may include a solid phase, a gaseous phase, or both. The solid phase of bauxite residue drying off-gas 2013 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of bauxite residue drying off-gas 2013 may comprise water (H₂O), argon (Ar), carbon dioxide (CO₂), nitrogen (N₂), oxygen (O₂), or a combination thereof.

Process 2000 may comprise blending and pelletizing 2020. Blending and pelletizing 2020 may include blending the dried bauxite residue 2011 with one or more effluents or discharges from an off-gas recapture system. The blend may be pelletized to form bauxite residue pellets 2021.

Bauxite residue pellets 2021 may include a solid phase, an aqueous phase, or both. The solid phase of bauxite residue pellets 2021 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of bauxite residue pellets 2021 may include water (H₂O), oxalic acid (C₂H₂O₄), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), or a combination thereof.

In some embodiments, process 2000 may comprise a first off-gas scrubbing 2004. The bauxite residue drying off-gas 2013 may be scrubbed to generate a first off-gas scrubber effluent 2015. For example, bauxite residue drying off-gas 2013 may be passed through a scrubber (e.g., a venturi scrubber) while a liquid phase is introduced into the scrubber. The liquid phase may capture solids from residue drying off-gas 2013 to generate the first off-gas scrubber effluent 2015.

The first off-gas scrubber effluent 2015 may include a solid phase, an aqueous phase, or both. The first off-gas scrubber effluent 2015 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), water (H₂O), or a combination thereof. First off-gas scrubber effluent 2015 may be incorporated into bauxite residue pellets 2021 during blending and pelletizing 2020.

Still referring to FIG. 2, process 2000 may comprise sodium carbonate roasting 2030. Sodium carbonate roasting 2030 may include roasting the bauxite residue pellets 2021 to generate roasted pellets 2031. Sodium carbonate roasting 2030 may transform some metal species within bauxite residue pellets 2021 to water soluble metal salts. Roasting off-gas 2033 may also be generated during sodium carbonate roasting 2030. During sodium carbonate roasting 2030, one or more of the reactions listed in Table 1 may occur.

TABLE 1
Exemplary Sodium Carbonate Roasting Reactions

CH_{4(g)} + 2 O_{2(g)} [symbol] CO_{2(g)} + 2 H₂O_{(g)}
2 C₂H_{6(g)} + 7 O_{2(g)} [symbol] 6 H₂O_{(g)} + 4 CO_{2(g)}
C₃H_{8(g)} + 5 O_{2(g)} [symbol] 4 H₂O_{(g)} + 3 CO_{2(g)}
CO_{(g)} + ½ O_{2(g)} [symbol] CO_{2(g)}
C₍ₛ₎ + O_{2(g)} [symbol] CO_{2(g)}
S_{2(g)} + 2 O_{2(g)} [symbol] 2 SO_{2(g)}
Na₂CO₃₍ₛ₎ [symbol] Na₂O₍ₛ₎ + CO_{2(g)}
AlO(OH)₍ₛ₎ + ½ Na₂O₍ₛ₎ [symbol] NaAlO₂₍ₛ₎ + ½ H₂O_{(g)}
2 FeO(OH)₍ₛ₎ [symbol] Fe₂O₃₍ₛ₎ + H₂O_{(g)}
2 Ca₅(PO₄)₃OH₍ₛ₎ [symbol] 3 Ca₂P₂O_{7(aq)} + H₂O_{(g)} + 4 CaO₍ₛ₎
Ca(OH)_{2(aq)} [symbol] CaO₍ₛ₎ + H₂O_{(g)}
CaCO₃₍ₛ₎ [symbol] CaO₍ₛ₎ + CO_{2(g)}
4 NaAlO₂₍ₛ₎ + CaO₍ₛ₎ [symbol] Na₂CaAl₄O₈₍ₛ₎ + Na₂O₍ₛ₎
Ca₂P₂O_{7(aq)} + 3 Na₂O₍ₛ₎ [symbol] 2 Na₃PO₄₍ₛ₎ + 2 CaO₍ₛ₎
SiO2₍ₛ₎ + Na₂O₍ₛ₎ [symbol] Na₂SiO_{3(aq)}
2 CaSO₄•2H₂O₍ₛ₎ [symbol] 2 CaO₍ₛ₎ + 2 SO_{2(g)} + 4 H₂O_{(g)} + O_{2(g)}
CaO₍ₛ₎ + Fe₂O₃₍ₛ₎ [symbol] CaO•Fe₂O₃₍ₛ₎
Na₂O₍ₛ₎ + Fe₂O₃₍ₛ₎ [symbol] 2 NaFeO_{2(aq)}
Fe₂O₃₍ₛ₎ [symbol] ⅔ Fe₃O₄₍ₛ₎ + ⅙ O_{2(g)}
CaSO₄•2H₂O₍ₛ₎ [symbol] CaSO₄₍ₛ₎ + 2 H₂O_{(g)}

Roasted pellets 2031 may include a solid phase, an aqueous phase, or both. The roasted pellets 2031 may comprise ammonium hydroxide (NH₄OH), arsenic trioxide (As₂O₃), calcium aluminosilicate (Ca₂Al₂SiO₇), calcium hydroxide (Ca(OH)₂), calcium iron oxide (CaO·Fe₂O₃), calcium pyrophosphate (Ca₂P₂O₇), calcium orthosilicate (Ca₂SiO₄), calcium sulfate (CaSO₄), cerium oxide (CeO₂), chromium oxide (Cr₂O₃), disodium phosphate (Na₂HPO₄), ferric oxide (Fe₂O₃), iron (Fe), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), sodium bicarbonate (NaHCO₃), sodium chromate (Na₂CrO₄), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), zirconyl hydroxide (ZrO(OH)₂), or a combination thereof.

Roasting off-gas 2033 may include a solid phase, a gaseous phase, or both. The solid phase of roasting off-gas 2033 may comprise aluminum hydroxide oxide (AlO(OH)), calcium carbonate (CaCO₃), calcium hydroxyphosphate (Ca₅(OH)(PO₄)₃), calcium sulfate dihydrate (CaSO₄·2H₂O), chromium oxide (Cr₂O₃), ferric oxide (Fe₂O₃), ferric oxyhydroxide (FeO(OH)), lanthanum (III) oxide (La₂O₃), magnesium hydroxide (Mg(OH)₂), manganese (II) hydroxide (Mn(OH)₂), potassium oxide (K₂O), arsenic trioxide (As₂O₃), calcium hydroxide (Ca(OH)₂), cerium oxide (CeO₂), neodymium (III) oxide (Nd₂O₃), niobium pentoxide (Nb₂O₅), silicon dioxide (SiO₂), sodium aluminate (NaAlO₂), sodium carbonate (Na₂CO₃), sodium metasilicate (Na₂SiO₃), sodium oxide (Na₂O), lead (II) oxide (PbO), nickel (II) oxide (NiO), scandium oxide (Sc₂O₃), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of roasting off-gas 2033 may comprise water (H₂O), argon (A), carbon dioxide (CO₂), nitrogen (N₂), oxygen (O₂), sulfur dioxide (SO₂), or a combination thereof.

Process 2000 may comprise roasted pellet grinding 2040. Roasted pellet grinding 2040 may include grinding roasted pellets 2031 to generate ground pellets 2041.

Ground pellets 2041 include a solid phase, an aqueous phase, or both. Ground pellets 2041 may comprise aluminum hydroxide (Al(OH)₃), aluminum hydroxide oxide (AlO(OH)), ammonium hydroxide (NH₄OH), arsenic trioxide (As₂O₃), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), chromium oxide (Cr₂O₃), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium aluminate (NaAlO₂), sodium bicarbonate (NaHCO₃), sodium carbonate (Na₂O₃), sodium chromate (Na₂CrO₄), sodium dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), or a combination thereof.

In some embodiments, process 2000 may comprise a second off-gas scrubbing 2006. Second off-gas scrubbing 2006 may include scrubbing the roasting off-gas 2033 to generate second off-gas scrubber effluent 2035. For example, roasting off-gas 2033 may be passed through a scrubber (e.g., a venturi scrubber) while a liquid phase is introduced into the scrubber. The liquid phase may remove solids from roasting off-gas 2033 to generate the second off-gas scrubber effluent 2035.

The second off-gas scrubber effluent 2035 may include a solid phase, an aqueous phase, or both. Second off-gas scrubber effluent 2035 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. Roasted pellet grinding 2040 may include combining the second off-gas scrubber effluent 2035 with the roasted pellets 2031 to generate ground pellets 2041.

Process 2000 may comprise aluminum leaching 2100. Aluminum leaching 2100 may include leaching ground pellets 2041 to generate an aluminum leachate 2101. For example, ground pellets 2041 may be introduced into a reaction vessel (e.g., a leaching tank). One or more compositions, such as, for example, a base (e.g., sodium hydroxide) and/or wash waste from one or more other process steps, may also be introduced into the reaction vessel. During aluminum leaching 2100 one or more of the reactions listed in Table 2 may occur.

TABLE 2
Exemplary Aluminum Leaching Reactions

NaOH₍ₛ₎ [symbol] NaOH_{(aq)}
NaAlSiO₄₍ₛ₎ [symbol] NaAlO₂₍ₛ₎ + SiO₂₍ₛ₎
NaAlO₂₍ₛ₎ + 2 H₂O₍ₗ₎ [symbol] Al(OH)_{3(aq)} + NaOH_{(aq)}
NaOH_{(aq)} + SiO₂₍ₛ₎ [symbol] NaHSiO_{3(aq)}
Na₂O₍ₛ₎ + H₂O₍ₗ₎ [symbol] 2 NaOH_{(aq)}
Na₃PO₄₍ₛ₎ + H₂O₍ₗ₎ [symbol] Na₂HPO_{4(aq)} + NaOH_{(aq)}
V₂O_{5(aq)} + 3H₂O₍ₗ₎ [symbol] 2 H₃VO_{4(aq)}
Na₂SiO_{3(aq)} + H₂O₍ₗ₎ [symbol] NaOH_{(aq)} + NaHSiO_{3(aq)}
As₂O₃₍ₛ₎ + H2O₍ₗ₎ + 2 NaOH_{(aq)} [symbol] 2 NaH₂AsO_{3(aq)}
2 Cr₂O₃₍ₛ₎ + 8 NaOH_{(aq)} + 18 Fe₂O₃₍ₛ₎ [symbol] 4 Na₂CrO_{4(aq)} + 4 H₂O₍ₗ₎ + 12 Fe₃O₄₍ₛ₎

After aluminum leaching 2100, the aluminum leachate 2101 may be discharged from the reaction vessel. Aluminum leachate 2101 may include a solid phase, an aqueous phase, or both. Aluminum leachate 2101 may comprise aluminum hydroxide (Al(OH)₃), aluminum hydroxide oxide (AlO(OH)) ammonium hydroxide (NH₄OH), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium bicarbonate (NaHCO₃), sodium carbonate (Na₂O₃), sodium chromate (Na₂CrO₄), sodium, dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), or a combination thereof.

Still referring to FIG. 2, process 2000 may include aluminum leach residue filtration 2110. Aluminum leach residue filtration 2110 may include filtering aluminum leachate 2101 to generate aluminum leach residue 2111 and aluminum leach filtrate 2113. Aluminum leach residue 2111 may include a solid phase, an aqueous phase, or both. Aluminum leach residue 2111 may comprise aluminum hydroxide (Al(OH)₃), aluminum hydroxide oxide (AlO(OH)), ammonium hydroxide (NH₄OH), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium bicarbonate (NaHCO₃), sodium carbonate (Na₂O₃), sodium chromate (Na₂CrO₄), sodium dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), water (H₂O), or a combination thereof. Aluminum leach filtrate 2113 may include an aqueous phase comprising aluminum hydroxide (Al(OH)₃), ammonium hydroxide (NH₄OH), disodium phosphate (Na₂HPO₄), oxalic acid (C₂H₂O₄), scandium oxalate (Sc₂(C₂O₄)₃), sodium bicarbonate (NaHCO₃), sodium carbonate (Na₂CO₃), sodium chromate (Na₂CrO₄), sodium dihydrogen arsenite (NaH₂AsO₃), sodium hydrogen metasilicate (NaHSiO₃), sodium hydroxide (NaOH), vanadic acid (H₃VO₄), zirconyl oxalate (ZrOC₂O₄), zirconyl hydroxide (ZrO(OH)₂), water (H₂O), or a combination thereof.

Process 2000 may comprise aluminum leach residue drying 2120. Aluminum leach residue drying 2120 may include drying aluminum leach residue 2111 to generate dried aluminum leach residue 2121. For example, aluminum leach residue 2111 may be passed to a paddle dryer configured to remove water from aluminum leach residue 2111 to generate dried aluminum leach residue 2121. Liquid water from aluminum leach residue 2111 may be converted to gaseous water and ventilated from the leach residue. The water content of dried aluminum leach residue 2121 may be less than approximately 1 wt. %, based on the total weight of dried aluminum leach residue 2121. For example, the water content of dried aluminum leach residue 2121 may be approximately 0.1% to approximately 25% of the water content of aluminum leach residue 2111. Aluminum leach residue drying off-gas 2123 may also be generated during aluminum leach residue drying 2120. During aluminum leach residue drying 2120, one or more of the reactions listed in Table 3 may occur.

TABLE 3
Exemplary Aluminum Leach Residue Drying Reactions

Al(OH)_{3(aq)} [symbol] Al(OH)₃₍ₛ₎
Na₂CO_{3(aq)} [symbol] Na₂CO₃₍ₛ₎
2 NaHCO_{3(aq)} [symbol] Na₂CO₃₍ₛ₎ + H₂O_{(g)} + CO_{2(g)}
2 NaHSiO_{3(aq)} [symbol] Na₂O•2SiO₂₍ₛ₎ + H₂O_{(g)}
2 NaOH_{(aq)} [symbol] Na₂O₍ₛ₎ + H₂O_{(g)}
2 Na₂HPO_{4(aq)} + Na₂O₍ₛ₎ [symbol] 2 Na₃PO₄₍ₛ₎ + H₂O_{(g)}

Dried aluminum leach residue 2121 may include a solid phase, a aqueous phase, or both. Dried aluminum leach residue may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O) scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), zirconyl oxalate (ZrOC₂O₄), or a combination thereof.

Aluminum leach residue drying off-gas 2123 may include a solid phase, a gaseous phase, or both. The solid phase of aluminum leach residue drying off-gas may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), or a combination thereof. The gaseous phase of aluminum leach residue drying off-gas 2123 may comprise water (H₂O), argon (Ar), carbon dioxide (CO₂), nitrogen (N₂), oxygen (O₂), or a combination thereof.

In some embodiments, process 2000 may comprise a third off-gas scrubbing 2008. The third off-gas scrubbing 2008 may include scrubbing the aluminum leach residue drying off-gas 2123 to generate a third off-gas scrubber effluent 2125. For example, aluminum leach residue drying off-gas 2123 may be passed through a scrubber (e.g., a venturi scrubber) while a liquid phase is introduced into the scrubber. The liquid phase may remove solids from aluminum leach residue drying off-gas 2123 to generate the third off-gas scrubber effluent 2125.

The third off-gas scrubber effluent 2125 may include a solid phase, an aqueous phase, or both. The solid phase of third off-gas scrubber effluent 2125 may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇) calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of third off-gas scrubber effluent 2125 may comprise ammonium hydroxide (NH₄OH), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), water (H₂O), or a combination thereof. Aluminum leaching 2100 may include introducing the third off-gas scrubber effluent 2125 to the ground pellets 2041.

Still referring to FIG. 2, process 2000 may comprise briquetting 2130. Briquetting 2130 may comprise introducing one or more briquette additives to dried aluminum leach residue 2121, and mechanically compressing the combined additives and dried aluminum leach residue 2121 to generate briquettes 2131.

Briquettes 2131 may include a solid phase, an aqueous phase, or both. The solid phase of briquettes 2131 may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄.2H₂O), carbon (C), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), sulfur (S₈), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of briquettes 3131 may comprise water (H₂O), oxalic acid (C₂H₂O₄), vanadic acid (H₃VO₄), sodium dihydrogen arsenite (NaH₂AsO₃), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Process 2000 may comprise reduction roasting 2140. Reduction roasting 2140 may include roasting briquettes 2131 (e.g., carbo-thermal roasting) to generate metallized briquettes 2141. For example, briquettes 2131 may be introduced into a reaction vessel (e.g., a furnace), and roasted at a temperature greater than or equal to approximately 1200° C. to generate metallized briquettes 2141. Reduction roasting 2140 may also generate reduction roasting off-gas 2143. Reduction roasting 2140 may include roasting the briquettes 2131 at a temperature of approximately 1250° C. to approximately 1500° C., such as, for example, approximately 1300° C. to approximately 1500° C., approximately 1250° C. to approximately 1450° C., or approximately 1300° C. to approximately 1370° C.

In some embodiments, air and/or other gases may be allowed to enter the reaction vessel during reduction roasting 2140. Alternatively, air and/or other gases may be excluded from the reaction vessel during reduction roasting 2140. During reduction roasting 2140, some, most, or all aqueous water present in briquettes 2131 may convert to gaseous water. In addition or alternatively, during reduction roasting 2140, one or more of the reactions listed in Table 4 may occur.

TABLE 4
Exemplary Reduction Roasting Reactions

2 VM₍ₛ₎ [symbol] 30 C₍ₛ₎ + 2 CO_{(g)} + 5 N_{2(g)} + 41 H_{2(g)}
CaO•Fe₂O₃₍ₛ₎ [symbol] CaO₍ₛ₎ + Fe₂O₃₍ₛ₎
2 NaFeO_{2(aq)} [symbol] Na₂O₍ₛ₎ + Fe₂O₃₍ₛ₎
6 FeO(OH)₍ₛ₎ + C₍ₛ₎ [symbol] 3 H2O_{(g)} + CO_{(g)} + 2 Fe₃O₄₍ₛ₎
3 Fe₂O₃₍ₛ₎ + C₍ₛ₎ [symbol] 2 Fe₃O₄₍ₛ₎ + CO_{(g)}
Fe₃O₄₍ₛ₎ + C₍ₛ₎ [symbol] 3 FeO_{(aq)} + CO_{(g)}
CaCO₃₍ₛ₎ [symbol] CaO₍ₛ₎ + CO_{2(g)}
Na₂CO₃₍ₛ) [symbol] Na₂O₍ₛ₎ + CO_{2(g)}
Ca₂P₂O_{7(aq)} + 2 Fe₍ₛ₎ + 5 C₍ₛ₎ [symbol] 2 CaO₍ₛ₎ + 2 FeP₍ₛ₎ + 5 CO_{(g)}
Na₃PO₄₍ₛ₎ + Fe₍ₛ₎ + 5/2 CO_{(g)} [symbol] FeP₍ₛ₎ + 3/2 Na₂O₍ₛ₎ + 5/2 CO_{2(g)}
Na₂CaAl₄O₈₍ₛ₎ [symbol] CaO₍ₛ₎ + 2 Al₂O₃₍ₛ₎ + Na₂O₍ₛ₎
2 AlO · OH₍ₛ₎ [symbol] Al₂O₃₍ₛ₎ + H₂O_{(g)}
Al(OH)₃₍ₛ₎ [symbol] ½ Al₂O₃₍ₛ₎ + 3/2 H₂O_{(g)}
Na₂SiO_{3(aq)} [symbol] Na₂O₍ₛ₎ + SiO₂₍ₛ₎
Al₂O₃₍ₛ₎ + 2 CaO₍ₛ₎ + SiO₂₍ₛ₎ [symbol] Ca₂Al₂SiO₇₍ₛ₎
Na₂O₍ₛ₎ + CO_{(g)} + ½ O_{2(g)} [symbol] Na₂Co₃₍ₛ₎
FeS₂₍ₛ₎ [symbol] Fe₍ₛ₎ + S_{2(g)}
Na₂O₍ₛ₎ + SiO₂₍ₛ₎ [symbol] Na₂SiO_{3(aq)}
CaSO₄₍ₛ₎ + CO_{(g)} [symbol] CaO₍ₛ₎ + SO_{2(g)} + CO_{2(g)}
2 CaO₍ₛ₎ + SiO2₍ₛ₎ [symbol] Ca₂SiO4₍ₛ₎
Mn(OH)₂₍ₛ₎ [symbol] MnO₍ₛ₎ + H2O_{(g)}
Mg(OH)₂₍ₛ₎ [symbol] MgO_{(aq)} + H₂O_{(g)}
S_{(aq)} [symbol] ½ S_{2(g)}
S_{2(g)} + 2 O_{2(g)} [symbol] 2 SO_{2(g)}
H_{2(g)} + CO_{2(g)} [symbol] H₂O_{(g)} + CO_{(g)}
O_{2(g)} + 2 C₍ₛ₎ [symbol] 2 CO_{(g)}

Metallized briquettes 2141 may include a solid phase, an aqueous phase, or both. The solid phase of metallized briquettes 2141 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. In some embodiments, metallized briquettes 2141 do not include any water in an aqueous phase.

Reduction roasting off-gas 2143 may include a solid phase, a gaseous phase, or both. The solid phase of reduction roasting off-gas 2143 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of reduction roasting off-gas 2143 may comprise water (H₂O), argon (Ar), carbon monoxide (CO), carbon dioxide (CO₂), nitrogen (N₂), oxygen (O₂), sulfur dioxide (SO₂), or a combination thereof.

Still referring to FIG. 2, in some embodiments, process 2000 may comprise off-gas afterburning 2170. Off-gas afterburning 2170 may include incinerating reduction roasting off-gas 2143 to generate incinerated off-gas 2171. In some embodiments, incinerated off-gas 2171 generated from off-gas afterburning 2170 may be passed to a boiler 2180. Boiler 2180 may comprise a thermal fluid that absorbs heat from incinerated off-gas 2171. In some embodiments, hexylcyclohexane (C₁₂H₂₄) is used as a thermal fluid. The thermal fluid may retain heat absorbed from the incinerated off-gas 2171, and distribute absorbed heat to components of a system for beneficiating bauxite residue 100. For example, components of the system for beneficiating bauxite residue 100 may require heat for operation during process 2000 for beneficiating bauxite residue 100, and the heat may be supplied from the thermal fluid. Off-gas generated by boiler 2180 (e.g., boiler off-gas 2181) may be used in the carbonization of vanadium removal filtrate 2201 during aluminum precipitation 2300.

In some embodiments, process 2000 may comprise product cooling 2150. Product cooling 2150 may include cooling the metallized briquettes 2141 to generate cooled briquettes 2151. Cooled briquettes 2151 may include a solid phase, an aqueous phase, or both. The solid phase of cooled briquettes 2151 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of cooled briquettes 2151 may comprise oxalic acid (C₂H₂O₄), sodium chromate (Na₂CrO₄), ammonium hydroxide (NH₄OH), scandium oxalate (Sc₂(C₂O₄)₃), sodium chromate (Na₂CrO₄), zirconyl hydroxide (ZrO(OH)₂), or a combination thereof.

Process 2000 may comprise briquette grinding 2160. Briquette grinding 2160 may including grinding cooled briquettes 2151 to generate ground briquettes 2161. For example, cooled briquettes 2151 may be ground until the average particle size is less than or equal to approximately 100 μm, such as, for example, less than or equal to approximately 75 μm, less than or equal to approximately 50 μm, approximately 25 μm to approximately 100 μm, approximately 25 μm to approximately 75 μm, approximately 25 μm to approximately 50 μm, or approximately 40 μm to approximately 50 μm.

The ground briquettes 2161 may include a solid phase, an aqueous phase, or both. The solid phase of ground briquettes 2161 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of ground briquettes 3161 may comprise oxalic acid (C₂H₂O₄), sodium chromate (Na₂CrO₄), ammonium hydroxide (NH₄OH), zirconyl hydroxide (ZrO(OH)₂), or a combination thereof.

Still referring to FIG. 2, in some embodiments, process 2000 may include magnetic separation 2400. Magnetic separation 2400 may include removing iron-containing species from ground briquettes 2161 to generate iron-rich stream 400. Slag residue 2401 may include material remaining from magnetic separation 2400 of ground briquettes 2161. For example, slag residue 2401 may include a solid phase, an aqueous phase, or both. The solid phase of slag residue 2401 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of slag residue 2401 may comprise water (H₂O), oxalic acid (C₂H₂O₄), sodium chromate (Na₂CrO₄), ammonium hydroxide (NH₄OH), zirconyl hydroxide (ZrO(OH)₂), or a combination thereof.

Process 2000 may comprise scandium precipitation 2500. Scandium precipitation 2500 may include forming a scandium precipitate 2501 from slag residue 2401. For example, slag residue 2401 may be introduced into a reaction vessel (e.g., a precipitation tank, a carbonization tank, or other suitable vessel) along with one or more other fluids. In some embodiments, a sodium carbonate/sodium bicarbonate solution generated during vanadium and phosphate removal 2200 is introduced into the scandium precipitation 2500 reaction vessel. In addition or alternatively, one or more off-gases generated during other steps of process 2000 may be introduced into the scandium precipitation 2500 reaction vessel. During scandium precipitation 2500, one or more of the reactions listed in Table 5 may occur.

TABLE 5
Exemplary Scandium Precipitation Reactions

Sc₂O₃₍ₛ₎ + 6 NaHCO_{3(aq)} [symbol] Sc₂(CO₃)_{3(aq)} + H₂O₍ₗ₎ + 3
Na₂CO_{3(aq)}
ZrO₂₍ₛ₎ + H₂O₍ₗ₎ [symbol] ZrO(OH)_{2(aq)}
CO_{2(g)} + Na₂CO_{3(aq)} + H₂O₍ₗ₎ [symbol] 2 NaHCO_{3(aq)}
CaO₍ₛ₎ + CO_{2(g)} [symbol] CaCO₃₍ₛ₎
Na₂O₍ₛ₎ + CO_{2(g)} [symbol] Na₂CO_{3(aq)}
MgO_{(aq)} + CO_{2(g)} + CaCO₃₍ₛ₎ [symbol] CaMg(CO₃)₂₍ₛ₎
MnO₍ₛ₎ + CO_{2(g)} [symbol] MnCO₃₍ₛ₎

After scandium precipitation 2500, a scandium precipitate 2501 may be discharged from the reaction vessel. Scandium precipitate 2501 may include a solid phase, an aqueous phase, or both. The solid phase of scandium precipitate 2501 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium magnesium carbonate (CaMg(CO₃)₂), calcium carbonate (CaCO₃), manganese carbonate (MnCO₃), carbon (C), cerium oxide (CeO₂), iron (Fe), iron phosphide (FeP), lanthanum (III) oxide (La₂O₃), lead (II) oxide (PbO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of scandium precipitate 2501 may comprise water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof.

In some embodiments, process 2000 comprises scandium precipitate filtration 2510. Scandium precipitate filtration 2510 may include filtering the scandium precipitate 2501. The residue from scandium precipitate filtration 2510 may contain species comprising calcium, silicon, and/or titanium. For example, the residue from scandium precipitate filtration 2510 may comprise calcium aluminosilicate (Ca₂Al₂SiO₇), calcium carbonate (CaCO₃), titanium dioxide (TiO₂), calcium hydroxide (Ca(OH)₂), calcium hydroxyphosphate (Ca(OH)(PO₄)₃, calcium orthosilicate (Ca₂SiO₄), calcium magnesium carbonate (CaMg(CO₃)₂), calcium carbonate (CaCO₃), or a combination thereof. The residue from scandium precipitate filtration 2510 may be removed and/or further processed to generate calcium/silicon/titanium-rich stream 500.

Scandium precipitate filtration 2510 may generate a filtrate (e.g., scandium precipitation filtrate 2511). Scandium precipitation filtrate 2511 may include an aqueous phase. In some embodiments, scandium precipitation filtrate 2511 comprises water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof.

In some embodiments, process 2000 may comprise scandium-zirconium ion exchange 2600. Scandium-zirconium ion exchange 2600 may include ion exchanging scandium precipitation filtrate 2511 to generate scandium-rich stream 600. For example, scandium precipitation filtrate 2511 may be introduced into a reaction vessel. An acid, such as, for example, an organic acid (e.g., oxalic acid) may also be introduced into the scandium-zirconium ion exchange 2600 reaction vessel. During scandium-zirconium ion exchange 2600, one or more of the reactions listed in Table 6 may occur.

TABLE 6
Exemplary Scandium-Zirconium Ion Exchange Reactions

Sc₂(CO₃)_{3(aq)} + 3 C₂H₂O_{4(aq)} + 3 Na₂CO_{3(aq)} [symbol] Sc₂(C₂O₄)_{3(aq)} + 6
NaHCO_{3(aq)}
ZrO(OH)_{2(aq)} + C₂H₂O_{4(aq)} [symbol] ZrOC₂O_{4(aq)} + 2 H₂O₍ₗ₎

Although Table 6 shows reactions with oxalic acid (C₂H₂O₄), this is one example. Any suitable acid may be used in scandium-zirconium ion exchange 2600.

Still referring to FIG. 2, in some embodiments, process 2000 may comprise vanadium and phosphate removal 2200. The aluminum leach filtrate 2113 generated during aluminum leach residue filtration 2110 may be processed to remove species comprising vanadium, generating vanadium-rich stream 200. For example, aluminum leach filtrate 2113 may be introduced into a reaction vessel. One or more other solutions may also be introduced into the vanadium and phosphate removal 2200 reaction vessel, such as, for example, an alkaline brine. During vanadium and phosphate removal 2200, one or more of the reactions listed in Table 7 may occur.

TABLE 7
Exemplary Vanadium and Phosphate Removal Reactions

6 Na₂HPO_{4(aq)} + 10 Ca(OH)₂₍ₛ₎ [symbol] 2 Ca₅(PO₄)₃OH₍ₛ₎ + 12 NaOH +
H₂O₍ₗ₎
H₂VO_{4(aq)} + NH₄OH_{(aq)} [symbol] NH₄VO₃₍ₛ₎ + H₂O₍ₗ₎

The product of vanadium and phosphate removal 2200 may be filtered to generated vanadium-rich stream 200. The filtration of species comprising vanadium during vanadium and phosphate removal 2200 may also generate a vanadium removal filtrate 2201. Vanadium removal filtrate 2201 may include an aqueous phase. Vanadium removal filtrate 2201 may comprise water (H₂O), aluminum hydroxide (Al(OH)₃), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

In some embodiments, process 2000 may comprise aluminum precipitation 2300. Aluminum precipitation 2300 may generating a precipitate from vanadium removal filtrate 2201. For example, aluminum precipitation 2300 may include introducing vanadium removal filtrate 2201 into a reaction vessel (e.g., a precipitation tank, a carbonization tank, or other suitable vessel). Aluminum precipitation 2300 may also include introducing one or more solutions into the reaction vessel. In addition or alternatively, aluminum precipitation 2300 may include bubbling one or more off-gases generated during process 2000 into the reaction vessel. During aluminum precipitation 2300, one or more of the reactions listed in Table 8 may occur.

TABLE 7
Exemplary Aluminum Precipitation Reactions

Na₂HPO_{4(aq)} + Al(OH)_{3(aq)} [symbol] AlPO₄₍ₛ₎ + H₂O₍ₗ₎ + 2
NaOH_{(aq)}
Al(OH)_{3(aq)} [symbol] Al(OH)₃₍ₛ₎
2 NaOH_{(aq)} + CO_{2(g)} [symbol] Na₂CO_{3(aq)} + H₂O₍ₗ₎
2 H₃VO_{4(aq)} [symbol] V₂O_{5(aq)} + 3 H₂O₍ₗ₎
Na₂CO_{3(aq)} + CO_{2(g)} + H₂O₍ₗ₎ [symbol] 2 NaHCO_{3(aq)}

After aluminum precipitation 2300, aluminum precipitate 2301 may be discharged from the reaction vessel. Aluminum precipitate 2301 may include a solid phase, an aqueous phase, or both. The solid phase of aluminum precipitate 2301 may comprise aluminum hydroxide (Al(OH)₃). For example aluminum precipitate 2301 may comprise greater than or equal to 95 wt. % aluminum hydroxide, based on the total weight of solids in aluminum precipitate 2301, such as for example, greater than or equal to 99 wt. %, or greater than or equal to 99.9 wt. %. The solid phase of aluminum precipitate 2301 may also comprise vanadium pentoxide (V₂O₅). The aqueous phase of aluminum precipitate 2301 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Still referring to FIG. 2, in some embodiments, process 2000 may comprise aluminum precipitate filtration 2310. Aluminum precipitate filtration 2310 may include filtering the aluminum precipitate 2301 generated during aluminum precipitation 2300. The residue generated from aluminum precipitate filtration may be further processed and/or removed to generate aluminum-rich stream 300. Aluminum precipitate filtration 2310 may also generate an aluminum precipitation filtrate 2311. Aluminum precipitation filtrate 2311 may include an aqueous phase. Aluminum precipitation filtrate 2311 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

In some embodiments, process 2000 may comprise filtrate evaporation 2320. The aluminum precipitation filtrate 2311 may comprise sodium carbonate, such as, for example, sodium carbonate in a hydrate complex. Filtrate evaporation 2320 may include evaporating aluminum precipitation filtrate 2311 to generate a sodium carbonate cake 2321. Sodium carbonate cake 2321 may comprise a solid phase and an aqueous phase. The solid phase of sodium carbonate cake 2321 may comprise sodium carbonate hydrate (Na₂CO₃·xH₂O). In some embodiments, sodium carbonate cake 2321 may comprise greater than or equal to approximately 95 wt. % sodium carbonate hydrate, based on the total weight of solids in sodium carbonate cake 2321, such as, for example, greater than or equal to approximately 97 wt. %, greater than or equal to approximately 99 wt. %, or greater than or equal to approximately 99.9 wt. %. The solid phase of sodium carbonate cake 2321 may also comprise sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂). The aqueous phase of sodium carbonate cake 2321 may comprise oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Sodium carbonate used in the beneficiation of the bauxite residue 100 may undergo sodium carbonate regeneration 2350, and may be returned to the process as regenerated sodium carbonate 700. For example, sodium carbonate used during process 2000 may undergo one or more drying processes to remove water from the sodium carbonate, converting the spent (e.g., used) sodium carbonate to regenerated sodium carbonate 700. Regenerated sodium carbonate 700 may include a solid phase and an aqueous phase. The solid phase of regenerated sodium carbonate 700 may comprise sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of regenerated sodium carbonate 700 may comprise greater than or equal to approximately 95 wt. % sodium carbonate (Na₂CO₃), based on the total weight of solids in regenerated sodium carbonate 700, such as, for example, greater than or equal to approximately 97 wt. %, greater than or equal to approximately 99 wt. %, greater than or equal to approximately 99.5 wt. %, or greater than or equal to approximately 99.9 wt. %. The aqueous phase of regenerated sodium carbonate 700 may comprise water (H₂O), oxalic acid (C₂H₂O₄), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), or a combination thereof.

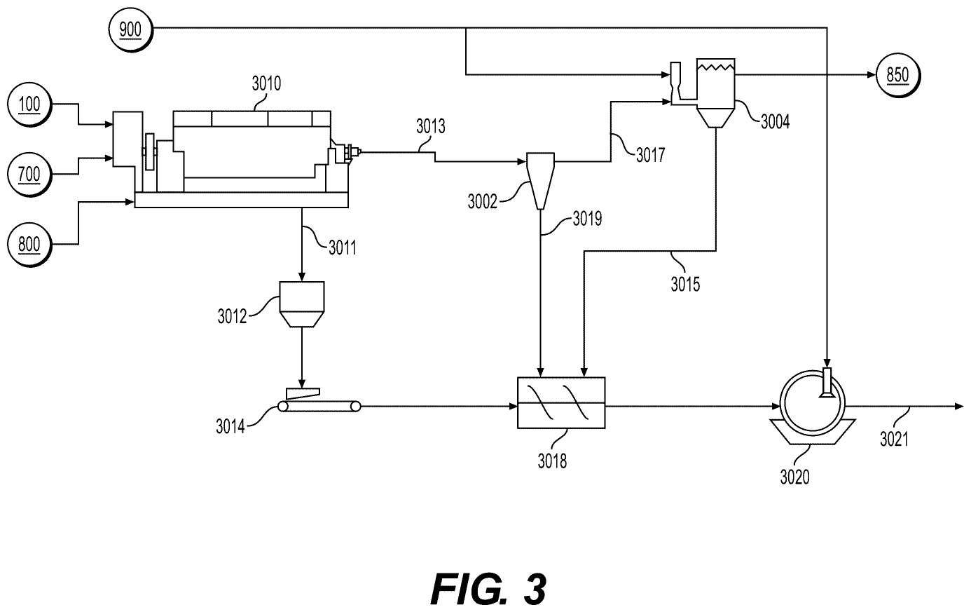

An exemplary system for beneficiating bauxite residue 100 is shown in FIGS. 3-13. Although certain components of a system for beneficiating bauxite residue 100 are shown, these components are not considered to be limiting or exhaustive. The schematic representations shown in FIGS. 3-13 are provided to show how components in an exemplary system for beneficiating bauxite residue 100 may interact with each other. The schematic representations are not intended to show every component of a suitable system for beneficiating bauxite residue 100. For example, various fans, pumps, heat circulators, conduits, and valves may not be shown in FIGS. 3-13, in order to improve the clarity of the components shown in those figures. Those of ordinary skill in the art will appreciate that one or more arrangements of fans, pumps, heat circulators, conduits, and valves may be used with the systems and methods described herein.

Although FIGS. 3-13 may show a component of a system for beneficiating bauxite residue 100 in a single configuration and context, it should be understood that components described herein may be used in additional configurations and/or contexts. For example, each component described of a system for beneficiating bauxite residue 100 may be used with one or more other components described herein. Further, systems, and components of systems, described in the present disclose may be used in combination of one or more steps of any method or process 1000, 2000 for beneficiating bauxite residue 100 described herein.

The description of FIGS. 3-13 may refer to water 900 introduced into the system (e.g., process water). Water 900 may refer to distilled water, filtered water, municipal water, or other water suitable for use in beneficiating bauxite residue 100. A described below, a system for beneficiating bauxite residue 100 may be configured to receive cooling water 910 and/or steam 920. Cooling water 910 may include distilled water, filtered water, municipal water, or other water suitable for use in beneficiating bauxite residue 100, that has a lower temperature than other components of the system. For example, cooling water 910 may be introduced to a system for beneficiating bauxite residue 100 at a temperature of approximately 25° C. Cooling water 910 may exit the system and return to a cooling tower 950, configured to assist in reducing the temperature of cooling water 910. Steam 920 may be introduced to a system for beneficiating bauxite residue 100 at a temperature greater than or equal to 100° C., such as, for example, 148° C.

The description of FIGS. 3-13 may refer to one or more streams passed to a stack 850. Stack 850 may include an outlet to the atmosphere or other exhaust for gases. In some embodiments, stack 850 may include one or more particle or gas capture devices that are configured to remove solids and/or gases from the exhaust from stack 850.

Referring to FIG. 3, a system for beneficiating bauxite residue 100 may comprise a bauxite residue paddle dryer 3010. Bauxite residue 100 may be introduced into bauxite residue paddle dryer 3010. Bauxite residue paddle dryer 3010 may be configured to receive sodium carbonate (Na₂CO₃), such as, for example, regenerated sodium carbonate 700. Bauxite residue paddle dryer 3010 may be configured to receive one or more gases, such as, for example air 800, during operation. Bauxite residue paddle dryer 3010 may convert liquid water to gaseous water, generating a dried bauxite residue 3011 and/or a bauxite residue drying off-gas 3013.

Dried bauxite residue 3011 may include a solid phase, an aqueous phase, or both. The water content of dried bauxite residue 3011 may be approximately one-third of the water content of bauxite residue 100. For example, the water content of dried bauxite residue 3011 may be approximately 25% to approximately 75% of the water content of bauxite residue 100. The solid phase of dried bauxite residue 3011 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of dried bauxite residue 3011 may comprise water (H₂O), oxalic acid (C₂H₂O₄), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), or a combination thereof.

Bauxite residue drying off-gas 3013 may include a solid phase, a gaseous phase, or both. The solid phase of bauxite residue drying off-gas 3013 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of bauxite residue drying off-gas 3013 may comprise water (H₂O), argon (Ar), carbon dioxide (CO₂), nitrogen (N₂), oxygen (O₂), or a combination thereof.

Bauxite residue drying off-gas 3013 may be passed to a bauxite residue dryer cyclone 3002. Bauxite residue dryer cyclone 3002 may be configured to separate particulates from bauxite residue drying off-gas 3013 via vortex separation. For example, bauxite residue dryer cyclone 3002 may generate cyclone off-gas 3017 (e.g., a low-density stream from cyclone 3002) and cyclone dust 3019 (e.g., a high-density stream from cyclone (3002) from bauxite residue drying off-gas 3013.

Cyclone off-gas 3017 may include a solid phase, a gaseous phase, or both. The solid phase of cyclone off-gas 3017 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of cyclone off-gas 3017 may comprise water (H₂O), argon (Ar), carbon dioxide (CO₂), nitrogen (N₂), oxygen (O₂), or a combination thereof. Cyclone off-gas 3017 may be passed to a first off-gas scrubber 3004.

Cyclone dust 3019 may include a solid phase comprising aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. Cyclone dust 3019 may be passed to sodium carbonate mixer 3018.

First off-gas scrubber 3004 may be configured to remove particulates from cyclone off-gas 3017. For example, first off-gas scrubber 3004 may be a venturi scrubber configured to receive a liquid phase (e.g., water 900) and cyclone off-gas 3017. The liquid phase may trap particulates from cyclone off-gas 3017, generating first off-gas scrubber effluent 3015. Off-gas from first off-gas scrubber 3004 may be passed to stack 850.

First off-gas scrubber effluent 3015 may include a solid phase, an aqueous phase, or both. First off-gas scrubber effluent 3015 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), water (H₂O), or a combination thereof. First off-gas scrubber effluent 3015 may be passed to sodium carbonate mixer 3018.

Dried bauxite residue 3011 may be passed to bauxite residue dosing bin 3012. Bauxide residue dosing bin 3012 may supply a feed of dried bauxite residue 3011 to a bauxite residue weighfeeder 3014. Bauxite residue weighfeeder 3014 and bauxite residue dosing bin 3012 may be configured to measure, control, and/or adjust the supply of dried bauxite residue 3011 to sodium carbonate mixer 3018.

Sodium carbonate mixer 3018 may be configured to blend dried bauxite residue 3011 with cyclone dust 3019 and/or first off-gas scrubber effluent 3015. The blended dried bauxite residue 3011, cyclone dust 3019, and/or first off-gas scrubber effluent 3015 may be passed to a pelletizer 3020, which may form bauxite residue pellets 3021. Optionally, water 900 may also be introduced into pelletizer 3020. For example, an amount of water 900 equivalent to approximately 15 wt. % of the total weight of blended dried bauxite residue 3011, cyclone dust 3019, and/or first off-gas scrubber effluent 3015 may be incorporated into bauxite residue pellets 3021.

Bauxite residue pellets 3021 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), ferric oxyhydroxide (FeO(OH)), hydroxylapatite (Ca₅(PO₄)₃OH), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium aluminate (NaAlO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), oxalic acid (C₂H₂O₄), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), water (H₂O), or a combination thereof.

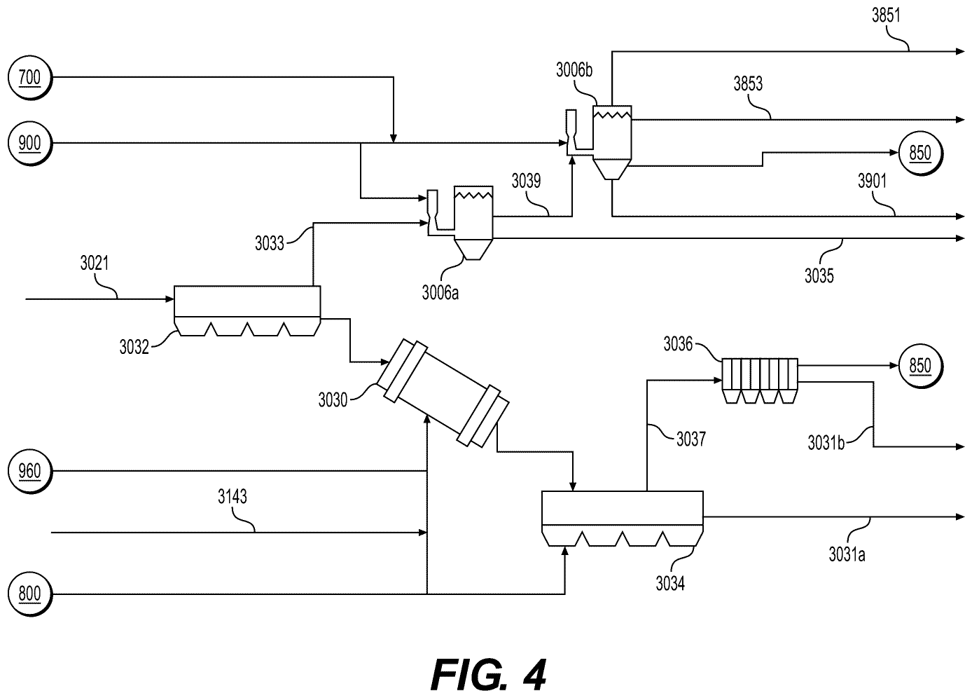

Referring to FIG. 4, a system for beneficiating bauxite residue 100 may comprise a roasting grate 3032, a roasting kiln 3030, and/or a roasting cooler 3034. The roasting grate 3032 may be configured to allow for a constant (or approximately constant) stream of bauxite residue pellets 3021 to be introduced into roasting kiln 3030. The bauxite residue pellets 3021 may be roasted in the roasting kiln 3030. The roasting kiln 3030 may be configured to receive a fuel (e.g., natural gas 960), and/or air 800. In some embodiments, roasting kiln 3030 may be configured to receive a reduction roasting off-gas 3143. During roasting, one or more of the reactions listed in Table 1 may occur.

The roasted product may be passed to roasting cooler 3034. Roasting cooler 3034 may be configured to allow a cooling gas (e.g., air) to be passed perpendicularly to the flow of product from roasting kiln 3030. As the cooling gas is passed through roasting cooler 3034, it may collect particulates from the product of roasting kiln 3030, forming cooler gas 3037. The cooler gas 3037 may then be passed to a cooler baghouse 3036. Cooler baghouse 3036 may remove roasted pellet dust 3031b from cooler gas 3037. The off-gas from cooler baghouse 3036 may be passed to stack 850.

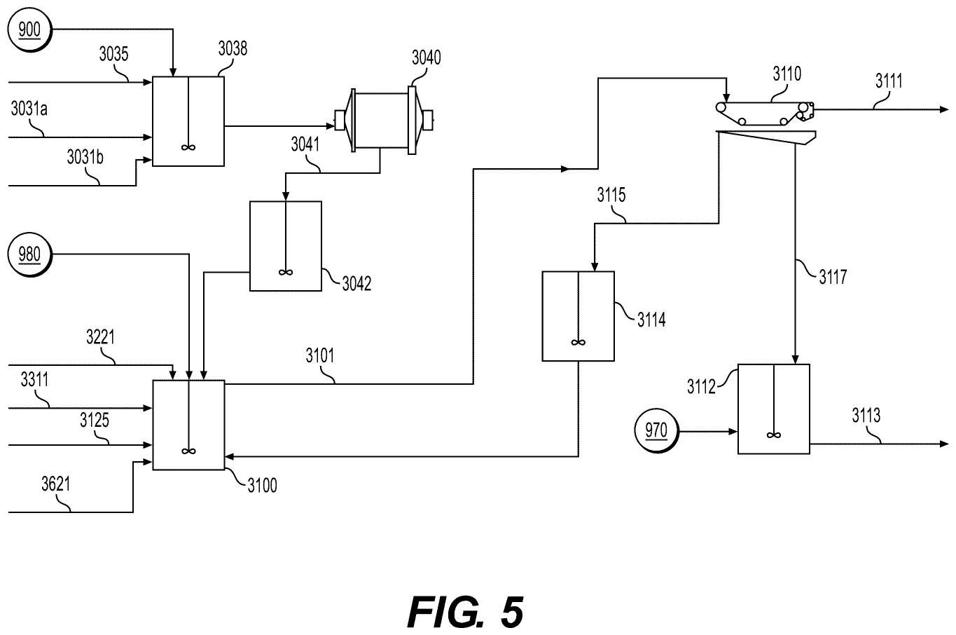

After roasted pellets 3031a formed in roasting kiln 3030, and are cooled in roasting cooler 3034, roasted pellets 3031a may be passed from cooler 3034 (e.g., to a roasted pellet grinding feed tank 3038, shown in FIG. 5). Roasted pellets 3031a may include a solid phase, an aqueous phase, or both. Roasted pellets 3031a may comprise a mmonium hydroxide (NH₄OH), arsenic trioxide (As₂O₃), calcium aluminosilicate (Ca₂Al₂SiO₇), calcium hydroxide (Ca(OH)₂), calcium iron oxide (CaO·Fe₂O₃), calcium pyrophosphate (Ca₂P₂O₇), calcium orthosilicate (Ca₂SiO₄), calcium sulfate (CaSO₄), cerium oxide (CeO₂), chromium oxide (Cr₂O₃), disodium phosphate (Na₂HPO₄), ferric oxide (Fe₂O₃), iron (Fe), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), sodium bicarbonate (NaHCO₃), sodium chromate (Na₂CrO₄), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), zirconyl hydroxide (ZrO(OH)₂), or a combination thereof.

A roasting off-gas 3033 may be generated by the operations of roasting grate 3032, roasting kiln 3030, and/or roasting cooler 3034. The roasting off-gas 3033 may include a solid phase, an aqueous phase, or both. The solid phase of roasting off-gas 3033 may comprise aluminum hydroxide oxide (AlO(OH)), calcium carbonate (CaCO₃), calcium hydroxyphosphate (Ca₅(OH)(PO₄)₃), calcium sulfate dihydrate (CaSO₄·2H₂O), chromium oxide (Cr₂O₃), ferric oxide (Fe₂O₃), ferric oxyhydroxide (FeO(OH)), lanthanum (III) oxide (La₂O₃), magnesium hydroxide (Mg(OH)₂), manganese (II) hydroxide (Mn(OH)₂), potassium oxide (K₂O), arsenic trioxide (As₂O₃), calcium hydroxide (Ca(OH)₂), cerium oxide (CeO₂), neodymium (III) oxide (Nd₂O₃), niobium pentoxide (Nb₂O₅), silicon dioxide (SiO₂), sodium aluminate (NaAlO₂), sodium carbonate (Na₂CO₃), sodium metasilicate (Na₂SiO₃), sodium oxide (Na₂O), lead (II) oxide (PbO), nickel (II) oxide (NiO), scandium oxide (Sc₂O₃), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of roasting off-gas 3033 may comprise water (H₂O), argon (A), carbon dioxide (CO₂), nitrogen (N₂), oxygen (O₂), sulfur dioxide (SO₂), or a combination thereof.

Roasting off-gas 3033 may be passed to a second off-gas scrubber 3006 (not shown in FIG. 4). In some embodiments, second off-gas scrubber 3006 includes a quench scrubber 3006a and a sulfur dioxide scrubber 3006b, and roasting off-gas 3033 may be passed to quench scrubber 3006a. Quench scrubber 3006a may be, for example, a venturi scrubber configured to receive a liquid phase (e.g., water 900). Quench scrubber 3006a may remove solids from roasting off-gas 3033 to generate a quench scrubber effluent 3035 and a quench scrubber off-gas 3039.

Quench scrubber effluent 3035 may include a solid phase, an aqueous phase (e.g., water), or both. Quench scrubber effluent 3035 may comprise aluminum hydroxide oxide (AlO(OH)), arsenic trioxide (As₂O₃), calcium carbonate (CaCO₃), calcium hydroxide (Ca(OH)₂), calcium hydroxyphosphate (Ca₅(OH)(PO₄)₃), calcium sulfate dihydrate (CaSO₄·2H₂O), cerium oxide (CeO₂), chromium oxide (Cr₂O₃), ferric oxide (Fe₂O₃), lanthanum (III) oxide (La₂O₃), lead (II) oxide (PbO), magnesium hydroxide (Mg(OH)₂), manganese (II) hydroxide (Mn(OH)₂), neodymium (III) oxide (Nd₂O₃), nickel (II) oxide (NiO), niobium pentoxide (Nb₂O₅), potassium oxide (K₂O), scandium oxide (Sc₂O₃), silicon dioxide (SiO₂), sodium carbonate (Na₂CO₃), sodium metasilicate (Na₂SiO₃), sodium oxide (Na₂O), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. Quench scrubber effluent 3035 may be passed from quench scrubber 3006a (e.g., to roasted pellet grinding feed tank 3038, shown in FIG. 5).

Quench scrubber off-gas 3039 may include a gaseous phase. Quench scrubber off-gas may comprise water (H₂O), argon (Ar), carbon dioxide (CO₂), nitrogen (N₂), oxygen (O₂), sulfur dioxide (SO₂), or a combination thereof. Quench scrubber off-gas 3039 may be passed to sulfur dioxide scrubber 3006b.

Sulfur dioxide scrubber 3006b may be configured to remove sulfur dioxide (SO₂) from quench scrubber off-gas 3039 to generate sulfur dioxide scrubber off-gas and a sulfur dioxide scrubber effluent 3901. Sulfur dioxide scrubber may utilize a scrubbing solution formed from regenerated sodium carbonate 700 and water 900 to remove sulfur dioxide (SO₂) from quench scrubber off-gas 3039. The sulfur dioxide scrubber off-gas may include a gaseous phase comprising water (H₂O), argon (Ar), carbon dioxide (CO₂), nitrogen (N₂), oxygen (O₂), or a combination thereof.

A first portion 3851 of the sulfur dioxide scrubber off-gas may be passed to an aluminum precipitation tank 3300. A second portion 3853 of the sulfur dioxide scrubber off-gas may be passed to a scandium precipitation tank 3500. Sulfur dioxide scrubber effluent 3901 may include a solid phase, an aqueous phase, or both. The solid phase of sulfur dioxide scrubber effluent 3901 may comprise sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The aqueous phase of sulfur dioxide scrubber effluent 3901 may comprise water (H₂O), oxalic acid (C₂H₂O₄), sodium carbonate (Na₂CO₃), disodium phosphate (Na₂HPO₄), sodium bicarbonate (NaHCO₃), sodium hydroxide (NaOH), sodium chromate (Na₂CrO₄), ammonium hydroxide (NH₄OH), scandium oxalate (Sc₂(C₂O₄)₃), zirconyl hydroxide (ZrO(OH)₂), or a combination thereof. Sulfur dioxide scrubber effluent 3901 may be passed to a waste water treatment module, system, or facility.

Referring to FIG. 5, a system for beneficiating bauxite residue 100 may include a roasted pellet grinding feed tank 3038. Roasted pellet grinding feed tank 3038 may be configured to receive quench scrubber effluent 3035, roasted pellets 3031a, roasted pellet dust 3031b, and/or water 900. Roasted pellet grinding feed tank 3038 may be configured to blend quench scrubber effluent 3035, roasted pellets 3031a, roasted pellet dust 3031b, and/or water 900. The blended quench scrubber effluent 3035, roasted pellets 3031a, roasted pellet dust 3031b, and/or water 900 may be passed to a pellet grinder 3040. The blend may be ground to generate ground pellets 3041.

Ground pellets 3041 may include a solid phase, an aqueous phase, or both. Ground pellets may comprise aluminum hydroxide (Al(OH)₃), aluminum hydroxide oxide (AlO(OH)), ammonium hydroxide (NH₄OH), arsenic trioxide (As₂O₃), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), chromium oxide (Cr₂O₃), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium aluminate (NaAlO₂), sodium bicarbonate (NaHCO₃), sodium carbonate (Na₂O₃), sodium chromate (Na₂CrO₄), sodium dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), or a combination thereof. Ground pellets 3041 may be passed to an aluminum leaching feed tank 3042.

Aluminum leaching feed tank 3042 may be configured to monitor, control, and/or adjust the stream of ground pellets 3041 to an aluminum leach tank 3100. Aluminum leach tank 3100 may be configured to receive ground pellets 3041, an alkaline compound (e.g., sodium hydroxide 980), a sodium carbonate/sodium biocarbonate stream 3211, aluminum precipitation wash filtrate 3311, third off-gas scrubber effluent 3125, and/or scandium ion exchange wash waste 3621. Aluminum leach tank 3100 may be configured to facilitate aluminum leaching of ground pellets 3041, and generate an aluminum leachate 3101. For example aluminum leach tank 3100 may facilitate one or more of the reactions listed in Table 2.

Aluminum leachate 3101 may include a solid phase, an aqueous phase, or both. Aluminum leachate 3101 may comprise aluminum hydroxide (Al(OH)₃), aluminum hydroxide oxide (AlO(OH)) ammonium hydroxide (NH₄OH), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium bicarbonate (NaHCO₃), sodium carbonate (Na₂O₃), sodium chromate (Na₂CrO₄), sodium, dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), water (H₂O), or a combination thereof. Aluminum leachate 3101 may be passed to an aluminum leach residue filter 3110.

Aluminum leach residue filter 3110 may separate aluminum leachate 3101 into aluminum leach residue 3111, an aluminum leach residue filtrate 3117, and an aluminum leach residue wash filtrate 3115. Aluminum leach residue 3111 may include a solid phase, an aqueous phase, or both. Aluminum leach residue 3111 may comprise aluminum hydroxide (Al(OH)₃), aluminum hydroxide oxide (AlO(OH)), ammonium hydroxide (NH₄OH), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), oxalic acid (C₂H₂O₄), potassium oxide (K₂O), scandium oxalate (Sc₂(C₂O₄)₃), scandium oxide (Sc₂O₃), silicon dioxide (SiO₂), sodium bicarbonate (NaHCO₃), sodium carbonate (Na₂O₃), sodium chromate (Na₂CrO₄), sodium dihydrogen arsenite (NaH₂AsO₃), sodium hydrogen metasilicate (NaHSiO₃), sodium hydroxide (NaOH), sodium iron oxide (NaFeO₂), sodium metasilicate (Na₂SiO₃), strontium oxide (SrO), thorium dioxide (ThO₂), titanium dioxide (TiO₂), vanadic acid (H₃VO₄), vanadium pentoxide (V₂O₅), yttrium (III) oxide (Y₂O₃), zirconium dioxide (ZrO₂), zirconyl hydroxide (ZrO(OH)₂), zirconyl oxalate (ZrOC₂O₄), water (H₂O), or a combination thereof.

Aluminum leach residue filtrate 3117 may include an aqueous phase comprising aluminum hydroxide (Al(OH)₃), ammonium hydroxide (NH₄OH), disodium phosphate (Na₂HPO₄), oxalic acid (C₂H₂O₄), scandium oxalate (Sc₂(C₂O₄)₃), sodium bicarbonate (NaHCO₃), sodium carbonate (Na₂CO₃), sodium chromate (Na₂CrO₄), sodium dihydrogen arsenite (NaH₂AsO₃), sodium hydrogen metasilicate (NaHSiO₃), sodium hydroxide (NaOH), vanadic acid (H₃VO₄), zirconyl oxalate (ZrOC₂O₄), zirconyl hydroxide (ZrO(OH)₂), water (H₂O), or a combination thereof. Aluminum leach residue wash filtrate 3115 may include an aqueous phase comprising aluminum hydroxide (Al(OH)₃), ammonium hydroxide (NH₄OH), disodium phosphate (Na₂HPO₄), oxalic acid (C₂H₂O₄), scandium oxalate (Sc₂(C₂O₄)₃), sodium bicarbonate (NaHCO₃), sodium carbonate (Na₂CO₃), sodium chromate (Na₂CrO₄), sodium dihydrogen arsenite (NaH₂AsO₃), sodium hydrogen metasilicate (NaHSiO₃), sodium hydroxide (NaOH), vanadic acid (H₃VO₄), zirconyl oxalate (ZrOC₂O₄), zirconyl hydroxide (ZrO(OH)₂), water (H₂O), or a combination thereof.

Aluminum leach residue wash filtrate 3115 may be passed to an aluminum leach residue wash filtrate tank 3114. Aluminum leach residue wash filtrate tank 3114 may retain aluminum leach residue wash filtrate 3115 prior to its introduction to aluminum leach tank 3100. In some embodiments, aluminum leach residue wash filtrate tank 3114 is configured to control, monitor, and/or adjust the flow of aluminum leach residue wash filtrate 3115 to aluminum leach tank 3100.

Aluminum leach residue filtrate 3117 may be passed from the aluminum leach residue filter 3110 to calcium phosphate precipitation tank 3112. Calcium phosphate precipitation tank 3112 may be configured to receive on or more alkaline solutions, such as, for example, calcium hydroxide (Ca(OH)₂) (e.g., slaked lime 970). Calcium phosphate precipitation tank 3112 may facilitate the conversion of aluminum leach residue filtrate 3117 and slaked lime 970 to a calcium phosphate slurry 3113. For example, the following reaction may occur in calcium phosphate precipitation tank 3112:

6Na₂HPO_{4(aq)}+10Ca(OH)₂₍ₛ₎⇄2Ca₅(PO₄)₃OH₍ₛ₎+12NaOH_{(aq)}+H₂O₍ₗ₎

Calcium phosphate slurry 3113 may include a solid phase, an aqueous phase, or both. The solid phase of calcium phosphate slurry 3113 may comprise at least 95 wt. % calcium hydroxyphosphate (Ca₅(OH)(PO₄)₃), based on the total weight of all solids in calcium phosphate slurry 3113, such as, for example, at least 99 wt. %, at least 99.5 wt. %, or at least 99.9 wt. %. The solid phase of calcium phosphate slurry 3113 may also include calcium hydroxide (Ca(OH)₂). The aqueous phase of calcium phosphate slurry 3113 may comprise aluminum hydroxide (Al(OH)₃), ammonium hydroxide (NH₄OH), disodium phosphate (Na₂HPO₄), oxalic acid (C₂H₂O₄), scandium oxalate (Sc₂(C₂O₄)₃), sodium bicarbonate (NaHCO₃), sodium carbonate (Na₂CO₃), sodium chromate (Na₂CrO₄), sodium dihydrogen arsenite (NaH₂AsO₃), sodium hydrogen metasilicate (NaHSiO₃), sodium hydroxide (NaOH), vanadic acid (H₃VO₄), zirconyl hydroxide (ZrO(OH)₂), zirconyl oxalate (ZrOC₂O₄), or a combination thereof.

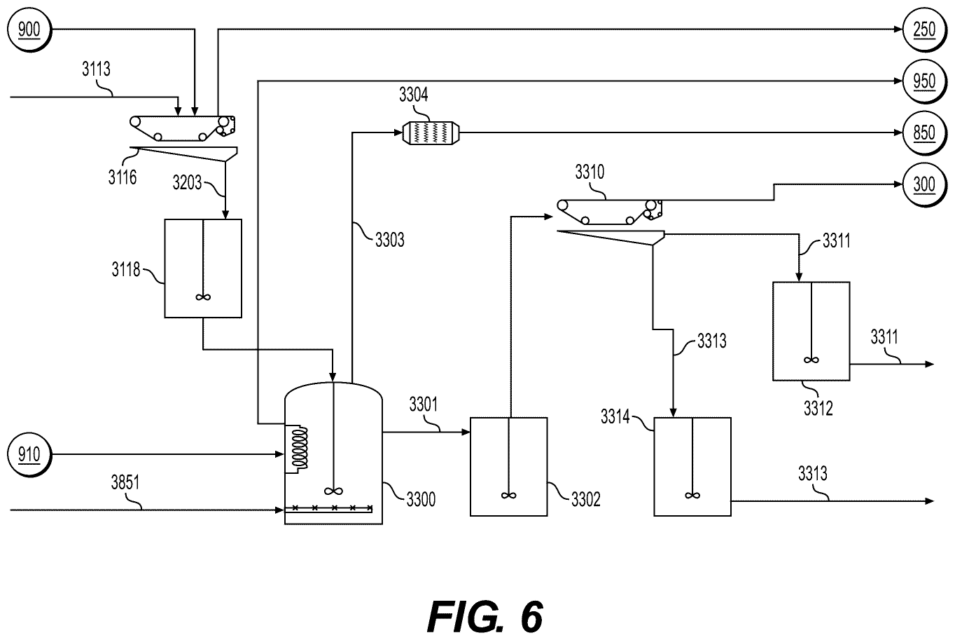

Referring to FIG. 6, a system for beneficiating bauxite residue 100 may include calcium phosphate filter 3116. Calcium phosphate filter 3116 may be configured to separate a calcium hydroxyphosphate filter cake 250 and a purified leachate 3203 from calcium phosphate slurry 3113. Calcium hydroxyphosphate filter cake 250 may include a solid phase, an aqueous phase, or both. The solid phase of calcium hydroxyphosphate filter cake 250 may comprise at least 95 wt. % calcium hydroxyphosphate (Ca₅(OH)(PO₄)₃), based on the total weight of all solids in calcium hydroxyphosphate filter cake 250, such as, for example, at least 99 wt. %, at least 99.5 wt. %, or at least 99.9 wt. %. The solid phase of calcium hydroxyphosphate filter cake 250 may also include calcium hydroxide (Ca(OH)₂). The aqueous phase of calcium hydroxyphosphate filter cake 250 may comprise aluminum hydroxide (Al(OH)₃), ammonium hydroxide (NH₄OH), disodium phosphate (Na₂HPO₄), oxalic acid (C₂H₂O₄), scandium oxalate (Sc₂(C₂O₄)₃), sodium bicarbonate (NaHCO₃), sodium carbonate (Na₂CO₃), sodium chromate (Na₂CrO₄), sodium dihydrogen arsenite (NaH₂AsO₃), sodium hydrogen metasilicate (NaHSiO₃), sodium hydroxide (NaOH), vanadic acid (H₃VO₄), zirconyl hydroxide (ZrO(OH)₂), zirconyl oxalate (ZrOC₂O₄), water (H₂O), or a combination thereof.

Purified leachate 3203 may include an aqueous phase comprising oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), water (H₂O), or a combination thereof. Purified leachate 3203 may be passed from calcium phosphate filter 3116 to a calcium phosphate filtrate feed tank 3118.

Calcium phosphate filtrate feed tank 3118 may be configured to monitor, control, and/or adjust the stream of purified leachate 3203 to aluminum precipitation tank 3300. Aluminum precipitation tank 3300 may be configured to receive purified leachate 3203, and to generate an aluminum precipitate 3301. For example, one or more gases (e.g., first portion 3851 of sulfur dioxide scrubber off-gas) may be bubbled through a solution including purified leachate 3203 within aluminum precipitation tank 3300. During generation of aluminum precipitate 3301, one or more of the reactions listed in Table 7 may occur within aluminum precipitation tank 3300. In some embodiments, aluminum precipitation tank 3300 is configured to receive cooling water 910, where the cooling water 910 enhances formation and/or recovery of aluminum precipitate 3301. After being passed through aluminum precipitation tank 3300, cooling water 910 is passed to cooling tower 950.

During the formation of aluminum precipitate 3301, aluminum precipitation gases 3303 may be generated. Aluminum precipitation gases 3303 may include a gaseous phase comprising water (H₂O), argon (Ar), carbon dioxide (CO₂), nitrogen (N₂), oxygen (O₂), or a combination thereof. Aluminum precipitation gases 3303 may be passed to an aluminum precipitation demister 3304, prior to being passed to stack 850. Demister 3304 may remove moisture or other liquid droplets entrained within aluminum precipitation gases 3303.

Aluminum precipitate 3301 may include a solid phase, an aqueous phase, or both. The solid phase of aluminum precipitate 3301 may comprise aluminum hydroxide (Al(OH)₃). For example aluminum precipitate 3301 may comprise greater than or equal to 95 wt. % aluminum hydroxide, based on the total weight of solids in aluminum precipitate 3301, such as for example, greater than or equal to 99 wt. %, or greater than or equal to 99.9 wt. %. The solid phase of aluminum precipitate 3301 may also comprise vanadium pentoxide (V₂O₅). The aqueous phase of aluminum precipitate 3301 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Aluminum precipitate 3301 may be evacuated from aluminum precipitation tank 3300 and passed to aluminum precipitation filter feed tank 3302. Aluminum precipitation filter feed tank 3302 may be configured to monitor, control, and/or adjust the stream of aluminum precipitate 3301 to aluminum precipitate filter 3310. Aluminum precipitate filter 3310 may separate aluminum-rich stream 300 from aluminum precipitate 3301. An aluminum precipitation filtrate 3313 and an aluminum precipitation wash filtrate 3311 may be formed by the separation of aluminum-rich rich stream 300 from aluminum precipitate 3301.

Aluminum precipitation wash filtrate 3311 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Aluminum precipitation wash filtrate 3311 may be passed to aluminum precipitation wash filtrate tank 3312. Aluminum precipitation wash filtrate tank 3312 may be configured to monitor, control, and/or adjust the stream of aluminum precipitation wash filtrate 3311 (e.g., to aluminum leach tank 3100).

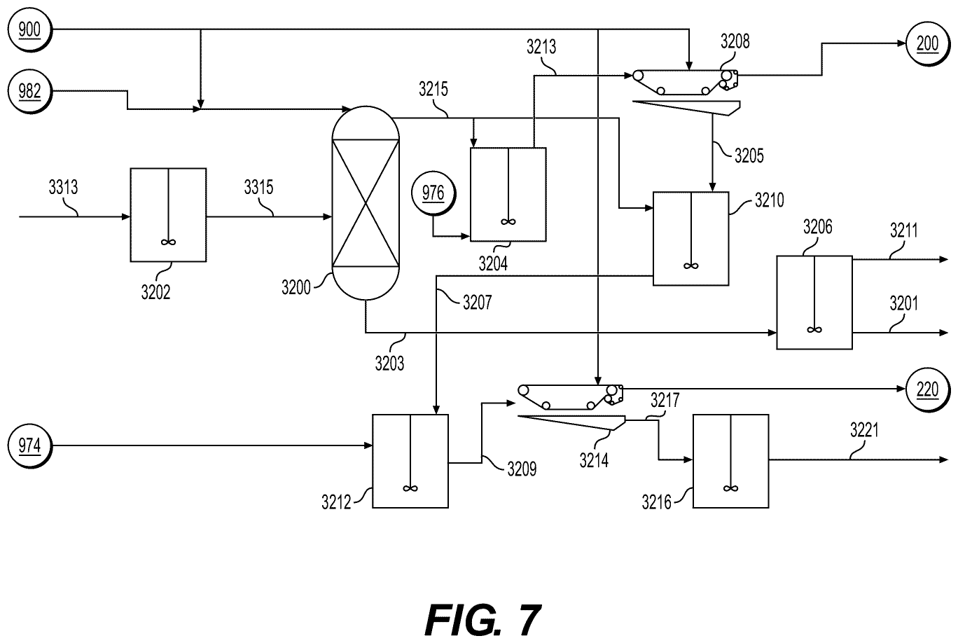

Aluminum precipitation filtrate 3313 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof. Aluminum precipitation filtrate 3313 may be passed to an aluminum precipitation filtrate tank 3314 and/or a vanadium ion exchange feed tank 3202 (shown in FIG. 7).

A system for beneficiating bauxite residue 100 may include a reaction vessel configured to facilitate a vanadium ion exchange reaction (e.g., vanadium ion exchange tank 3200). For example, a vanadium ion exchange tank 3200 may facilitate the following reaction:

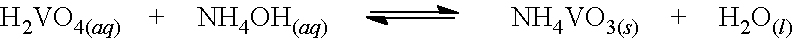

Referring to FIG. 7, vanadium ion exchange tank 3200 may include a reaction vessel configured to receive an ammonium metavanadate precipitation feed 3315, water 900, and/or sodium hydroxide brine 982. During and/or after a vanadium ion exchange operation, ammonium metavanadate precipitation feed 3215 may be passed from vanadium ion exchange tank 3200 to ammonium metavanadate precipitation tank 3204 and/or chromium precipitation feed tank 3210. In addition or alternatively, purified leachate 3203 may be passed from vanadium ion exchange tank 3200 to purified leachate tank 3206.

Ammonium metavanadate precipitation feed 3315 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Purified leachate 3203 may include an aqueous phase comprising aluminum hydroxide (Al(OH)₃), water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof. Purified leachate tank 3206 may separate purified leachate 3203 into sodium carbonate/sodium bicarbonate stream 3211 and purified aluminum leachate 3201.

Sodium carbonate/sodium bicarbonate stream 3211 may comprise sodium carbonate (Na₂CO₃), sodium bicarbonate (NaHCO₃), or both. Purified aluminum leachate 3201 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Ammonium metavanadate precipitation tank 3204 may be configured to receive ammonium metavanadate precipitation feed 3215 and/or ammonium hydroxide 976. Precipitation of ammonium metavanadate (NH₄VO₃) may be initiated, promoted, enhanced and/or maintained within ammonium metavanadate precipitation tank 3204. An ammonium metavanadate stream 3213 may be discharged from ammonium metavanadate precipitation tank 3204, and passed to a ammonium metavanadate filter 3208. Ammonium metavanadate stream 3213 may include a solid phase, an aqueous phase, or both. The solid phase of ammonium metavanadate stream 3213 may comprise at least approximately 95 wt. % ammonium metavanadate (NH₄VO₃), based on the total weight of solids of ammonium metavanadate stream 3213, such as, for example, at least approximately 98 wt. %, at least approximately 99 wt. %, at least approximately 99.5 wt. %, at least approximately 99.9 wt. %, or approximately 100 wt. %. The aqueous phase of ammonium metavanadate stream 3213 may comprise water (H₂O), vanadic acid (H₃VO₄), sodium hydroxide (NaOH), sodium chromate (NaCrO₄), or a combination thereof.

The ammonium metavanadate filter 3208 may separate vanadium-rich stream 200, ammonium metavanadate filtrate 3205, or both, from ammonium metavanadate stream 3213. A wash filtrate may also be generated by introducing water 900 to ammonium metavanadate filter 3208. The wash filtrate may be combined with ammonium metavanadate filtrate 3205. Ammonium metavanadate filtrate 3205 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof. Ammonium metavanadate filtrate 3205 may be passed to chromium precipitation feed tank 3210.

Chromium precipitation feed tank 3210 is configured to receive ammonium metavanadate precipitation feed 3215, ammonium metavanadate filtrate 3205, or both. Ammonium metavanadate precipitation feed 3215 and ammonium metavanadate filtrate 3205 may be blended within chromium precipitation feed tank 3210 to generate chromium precipitation feed 3207. Chromium precipitation feed 3207 may be discharged from chromium precipitation feed tank 3210, and/or passed to a chromium precipitation tank 3212. Chromium precipitation feed tank 3210 may be configured to monitor, control, and/or adjust a stream of chromium precipitation feed 3207 to chromium precipitation tank 3212. Chromium precipitation feed 3207 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Chromium precipitation tank 3212 may be configured to receive chromium precipitation feed 3207, sodium metabisulfite 974, or both. Chromium precipitation tank 3212 may facilitate one or more chromium precipitation reactions. For example, the following reaction may occur within chromium precipitation tank 3212:

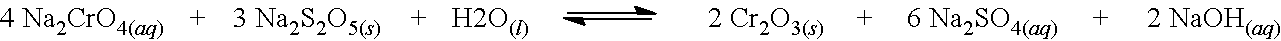

During or after one or more precipitation reactions have occurred, a chromium oxide stream 3209 may be discharged from chromium precipitation tank 3212, and/or passed to chromium oxide filter 3214. Chromium oxide stream 3209 may include a solid phase, an aqueous phase, or both. The solid phase of chromium oxide stream 3209 may comprise at least approximately 95 wt. % chromium oxide (Cr₂O₃), based on the total weight of solids of chromium oxide stream 3209, such as, for example, at least approximately 98 wt. %, at least approximately 99 wt. %, at least approximately 99.5 wt. %, at least approximately 99.9 wt. %, or approximately 100 wt. %. The aqueous phase of chromium oxide stream 3209 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof.

Chromium oxide filter 3214 may separate a chromium oxide cake 220, a chromium oxide filtrate 3217, or both, from chromium oxide stream 3209. Chromium oxide cake 220 may include a solid phase, an aqueous phase, or both. The solid phase of chromium oxide cake 220 may comprise at least approximately 95 wt. % chromium oxide (Cr₂O₃), based on the total weight of solids of chromium oxide cake 220, such as, for example, at least approximately 98 wt. %, at least approximately 99 wt. %, at least approximately 99.5 wt. %, at least approximately 99.9 wt. %, or approximately 100 wt. %. The aqueous phase of chromium oxide cake 220 may comprise water (H₂O), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), scandium oxalate (Sc₂(C₂O₄)₃), zirconyl oxalate (ZrOC₂O₄), or a combination thereof.

Chromium oxide filtrate 3217 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof. Chromium oxide filtrate 3217 may be passed to chromium oxide filtrate tank 3216.

Chromium oxide filtrate tank 3216 may collected and/or retain chromium oxide filtrate 3217. A depleted vanadium eluate 3221 may be discharged from chromium oxide filtrate tank 3216. Depleted vanadium eluate 3221 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), or a combination thereof. In some embodiments, depleted vanadium eluate 3221 and chromium oxide filtrate 3217 may have the same composition.

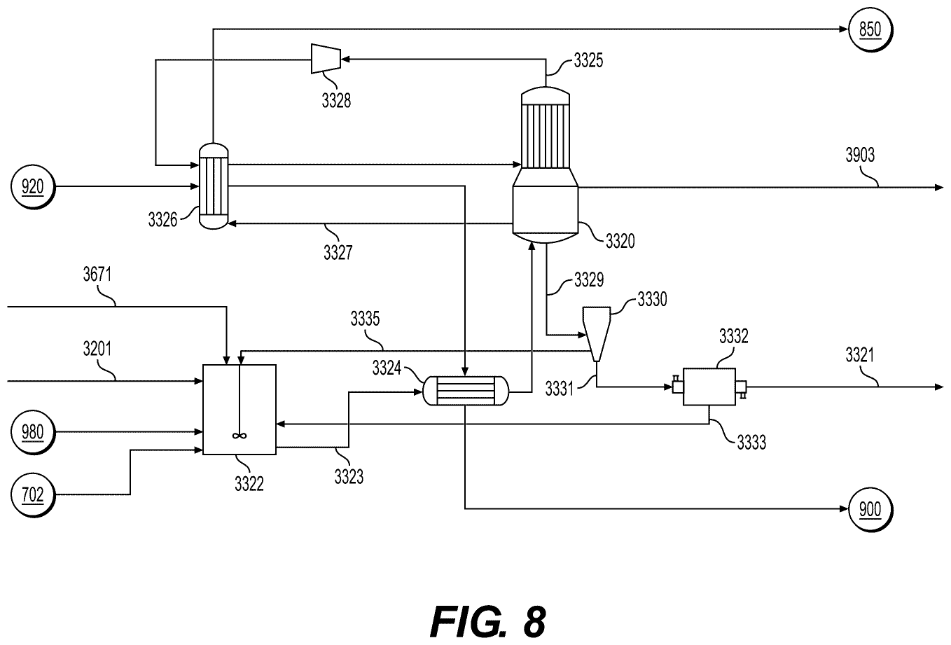

Referring to FIG. 8, in some embodiments, a system for beneficiating bauxite residue 100 may include a sodium carbonate evaporator 3320. In addition or alternatively, the system may include a sodium carbonate evaporator feed tank 3322. Sodium carbonate evaporator feed tank 3322 may be configured to receive sodium hydroxide 980, sodium carbonate dust 702, and/or one or more sources of spent sodium carbonate (e.g., streams containing aqueous complexes including sodium carbonate, such as, for example, impurity bleed 3671 or purified aluminum leachate 3201.) Sodium carbonate evaporator feed tank 3322 may be configured to monitor, control, and/or adjust a stream of sodium carbonate preheating feed 3323 to sodium carbonate evaporator preheater 3324, sodium carbonate evaporator 3320, or both.

Sodium carbonate preheating feed 3323 may include a solid phase, an aqueous phase, or both. The solid phase of sodium carbonate preheating feed 3323 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of sodium carbonate preheating feed 3323 may include at least approximately 80 wt. % sodium carbonate hydrate (Na₂CO₃·xH₂O), based on the total weight of solids within sodium carbonate preheating feed 3323, such as, for example, at least approximately 90 wt. %, at least approximately 95 wt. %, or at least approximately 99 wt. %. The aqueous phase of sodium carbonate preheating feed 3323 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Sodium carbonate evaporator preheater 3324 may heat sodium carbonate preheating feed 3323 prior to the introduction of sodium carbonate preheating feed 3323 to sodium carbonate evaporator 3320. Sodium carbonate evaporator 3320 may remove water from sodium carbonate preheating feed 3323 to generate sodium carbonate evaporator concentrate 3329. For example, liquid water from sodium carbonate preheating feed 3323 may be evaporated and removed from sodium carbonate evaporator as sodium carbonate evaporator exhaust 3325. Sodium carbonate evaporator condensate 3327, concentrated waste brine 3903, or both, may also be generated by sodium carbonate evaporator 3320. One or more of the reactions listed in Table 9 may occur within sodium carbonate evaporator 3320.

TABLE 9
Exemplary Sodium Carbonate Evaporation Reactions

NaHCO3(aq) + NaOH(aq) [symbol] Na2CO3(aq) + H2O(l)
Na₂CO_{3(aq)} + H₂O₍ₗ₎ [symbol] Na₂CO₃•xH₂O₍ₛ₎

Concentrated waste brine 3903 may include an aqueous phase comprising water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof. Concentrated waste brine 3903 may be passed to a waste water treatment module, system, or facility.

Sodium carbonate evaporator condensate 3327 may include a solid phase, an aqueous phase, or both. The solid phase of sodium carbonate evaporator condensate 3327 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of sodium carbonate evaporator condensate 3327 may include at least approximately 90 wt. % sodium carbonate hydrate (Na₂CO₃·xH₂O), based on the total weight of solids within sodium carbonate evaporator condensate 3327, such as, for example, at least approximately 95 wt. %, at least approximately 99 wt. %, at least approximately 99.5 wt. %, or at least approximately 99.9 wt. %. The aqueous phase of sodium carbonate evaporator condensate 3327 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Sodium carbonate evaporator exhaust 3325 may include a gaseous phase comprising water (H₂O). Sodium carbonate evaporator exhaust 3325 may comprise approximately 100 wt. % water, based on the total weight of sodium carbonate evaporator exhaust 3325. Sodium carbonate evaporator exhaust 3325 may be passed to a sodium carbonate evaporator vapor condenser 3328 and sodium carbonate evaporator heater 3326. Sodium carbonate evaporator vapor condenser 3328 may condense sodium carbonate evaporator exhaust 3325 to a liquid.

The heat from sodium carbonate evaporator exhaust 3325 may be reintroduced to sodium carbonate evaporator 3320 (e.g., via sodium carbonate evaporator heater 3326). In some embodiments, sodium carbonate evaporator condensate 3327 is passed through sodium carbonate evaporator heater 3326 and reintroduced to sodium carbonate evaporator 3320. Sodium carbonate evaporator heater 3326 may increase the temperature of sodium carbonate evaporator condensate 3327 prior to its reintroduction to sodium carbonate evaporator.

Off-gas generated by sodium carbonate evaporator heater 3326 may be passed to stack 850. Sodium carbonate evaporator heater 3326 may be configured to receive steam 920. Steam 920 may provide a heat source for sodium carbonate evaporator heater 3326. After steam 920 is passed to sodium carbonate evaporator heater 3326, it may be passed to sodium carbonate evaporator preheater 3324, and may provide a heat source to sodium carbonate evaporator preheater 3324. After being passed to sodium carbonate evaporator preheater 3324, steam 920 may be condensed and returned to process water supply (e.g., water 900).

Sodium evaporator concentrate 3329 may include a solid phase, an aqueous phase, or both. The solid phase of sodium evaporator concentrate 3329 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of sodium evaporator concentrate 3329 may include at least approximately 90 wt. % sodium carbonate hydrate (Na₂CO₃·xH₂O), based on the total weight of solids within sodium evaporator concentrate 3329, such as, for example, at least approximately 95 wt. %, at least approximately 99 wt. %, at least approximately 99.5 wt. %, or at least approximately 99.9 wt. %. The aqueous phase of sodium evaporator concentrate 3329 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Sodium evaporator concentrate 3329 may be passed to a sodium carbonate hydrocyclone 3330. Sodium carbonate hydrocyclone 3330 may utilize vortex separation to separate sodium evaporator concentrate 3329 into a high-density stream (e.g., hydrocyclone underflow 3331) and a low-density stream (e.g, hydrocyclone overflow 3335). The hydrocyclone underflow 3331 may be passed to a sodium carbonate centrifuge 2332. The hydrocyclone overflow 3335 may be passed to sodium carbonate evaporator feed tank 3322.

Hydrocyclone underflow 3331 may include a solid phase, an aqueous phase, or both. The solid phase of hydrocyclone underflow 3331 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of hydrocyclone underflow 3331 may include at least approximately 90 wt. % sodium carbonate hydrate (Na₂CO₃·xH₂O), based on the total weight of solids within hydrocyclone underflow 3331, such as, for example, at least approximately 95 wt. %, at least approximately 99 wt. %, at least approximately 99.5 wt. %, or at least approximately 99.9 wt. %. The aqueous phase of hydrocyclone underflow 3331 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Hydrocyclone overflow 3335 may include a solid phase, an aqueous phase, or both. The solid phase of hydrocyclone overflow 3335 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of hydrocyclone overflow 3335 may include at least approximately 90 wt. % sodium carbonate hydrate (Na₂CO₃·xH₂O), based on the total weight of solids within hydrocyclone overflow 3335, such as, for example, at least approximately 95 wt. %, at least approximately 99 wt. %, at least approximately 99.5 wt. %, or at least approximately 99.9 wt. %. The aqueous phase of hydrocyclone overflow 3335 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

Sodium carbonate centrifuge 3332 may utilize centrifugal force to remove a portion of the aqueous phase of hydrocyclone underflow 3331 to generate a centrifuge centrate 3333 and a sodium carbonate cake 3321.

Centrifuge centrate 3333 may include a solid phase, an aqueous phase, or both. The solid phase of centrifuge centrate 3333 may comprise sodium carbonate hydrate (Na₂CO₃·xH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of centrifuge centrate 3333 may include at least approximately 90 wt. % sodium carbonate hydrate (Na₂CO₃·xH₂O), based on the total weight of solids within centrifuge centrate 3333, such as, for example, at least approximately 95 wt. %, at least approximately 99 wt. %, at least approximately 99.5 wt. %, or at least approximately 99.9 wt. %. The aqueous phase of centrifuge centrate 3333 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof. Centrifuge centrate 3333 may be passed to sodium carbonate evaporator feed tank 3322.

Sodium carbonate cake 3321 may include a solid phase, an aqueous phase or both. The solid phase of sodium carbonate cake 3321 may comprise sodium carbonate hydrate (Na₂CO₃·XH₂O), sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The solid phase of sodium carbonate cake 3321 may include at least approximately 90 wt. % sodium carbonate hydrate (Na₂CO₃·xH₂O), based on the total weight of solids within sodium carbonate cake 3321, such as, for example, at least approximately 95 wt. %, at least approximately 99 wt. %, at least approximately 99.5 wt. %, or at least approximately 99.9 wt. %. The aqueous phase of sodium carbonate cake 3321 may comprise water (H₂O), oxalic acid (C₂H₂O₄), vanadic acid (H₃VO₄), sodium carbonate (Na₂CO₃), sodium dihydrogen arsenite (NaH₂AsO₃), disodium phosphate (Na₂HPO₄), sodium bicarbonate (NaHCO₃), sodium hydrogen metasillicate (NaHSiO₃), sodium hydroxide (NaOH), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

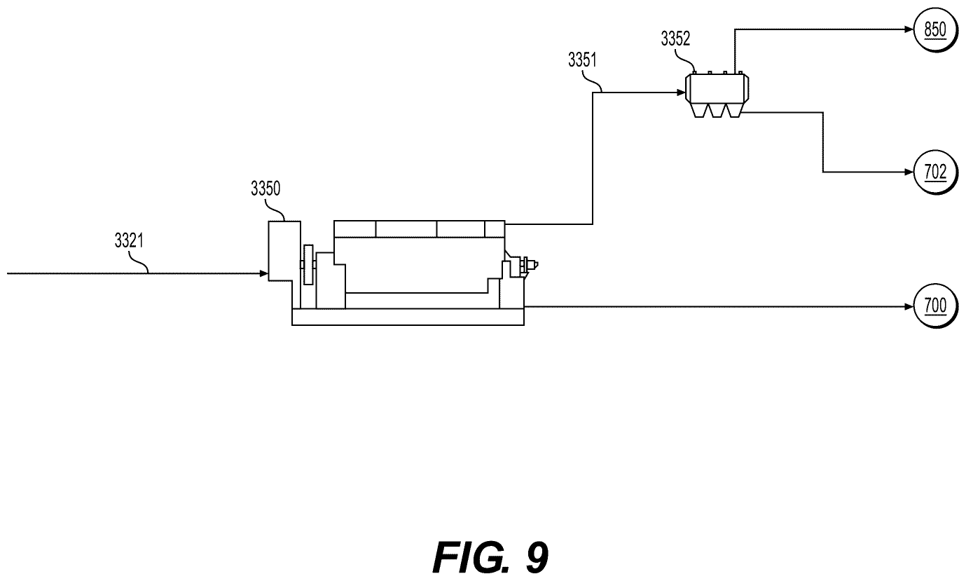

Referring to FIG. 9, sodium carbonate cake 3321 may be passed to a sodium carbonate paddle dryer 3350. Sodium carbonate paddle dryer 3350 may convert water from sodium carbonate cake 3321 to gaseous water to form regenerated sodium carbonate 700. For example, liquid water from the aqueous phase of sodium carbonate cake 3321 may be converted to gaseous water. Additionally, sodium carbonate hydrate (Na₂CO₃·xH₂O) may decompose within sodium carbonate paddle dryer 3350 to generate sodium carbonate (Na₂CO₃) and gaseous water. Sodium carbonate paddle dryer 3350 may generate sodium carbonate paddle dryer exhaust 3351.

Sodium carbonate paddle dryer exhaust 3351 may include a solid phase, a gaseous phase, or both. The solid phase of sodium carbonate paddle dryer exhaust 3351 may comprise sodium carbonate (Na₂CO₃), sodium oxide (NaO), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. The gaseous phase of solid phase of sodium carbonate paddle dryer exhaust 3351 may comprise water (H₂O), argon (Ar), carbon dioxide (CO₂), nitrogen (N₂), oxygen (O₂), or a combination thereof. Sodium carbonate paddle dryer exhaust 3351 may be passed to a sodium carbonate electrostatic precipitator 3352.

Sodium carbonate electrostatic precipitator 3352 may remove particulates from sodium carbonate paddle dryer exhaust 3351, using an electrostatic charge, to form sodium carbonate dust 702. The remaining sodium carbonate paddle dryer exhaust 3351 that is not converted to sodium carbonate dust 702 may be passed to stack 850. Sodium carbonate dust 702 may include sodium carbonate (Na₂CO₃), sodium oxide (Na₂O), silicon dioxide (SiO₂), arsenic trioxide (As₂O₃), sodium metasilicate (Na₂SiO₃), vanadium pentoxide (V₂O₅), zirconium dioxide (ZrO₂), or a combination thereof. Sodium carbonate dust 702 may include at least approximately 95 wt. % sodium carbonate (Na₂CO₃), based on the total weight of sodium carbonate dust, such as, for example, at least approximately 99 wt. %, at least approximately 99.5 wt. %, or at least approximately 99.9 wt. %.

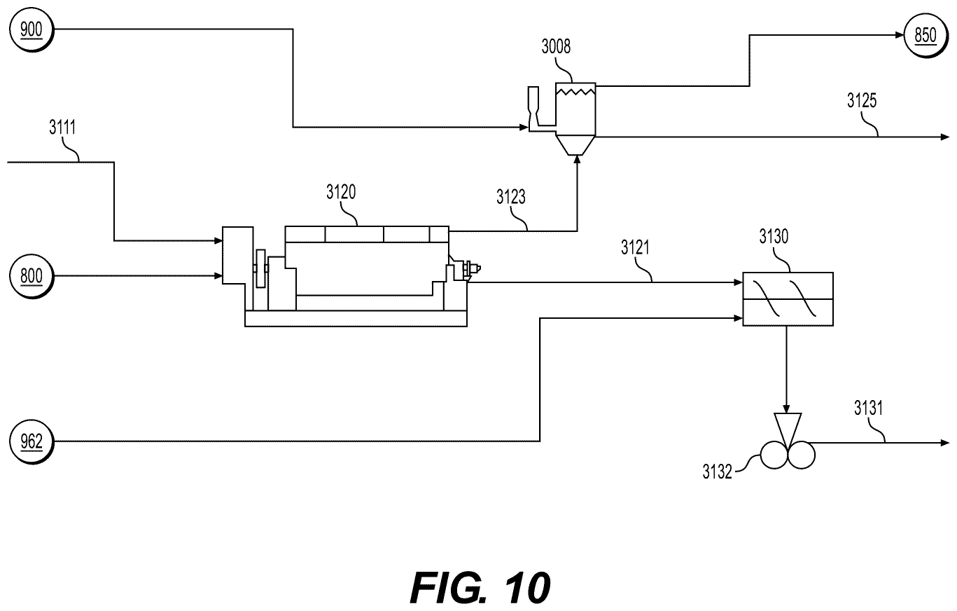

Referring to FIG. 10, a system for beneficiating bauxite residue 100 may include an aluminum leach residue dryer 3120. Aluminum leach residue dryer 3120 may be configured to receive aluminum leach residue 3111. In some embodiments, aluminum leach residue dryer 3120 is a paddle dryer configured to receive air 800. Aluminum leach residue dryer 3120 may remove water from aluminum leach residue 3111, generating dried aluminum leach residue 3121 and/or aluminum leach residue drying off-gas 3123. For example, one or more of the reactions listed in Table 3 may occur within aluminum leach residue dryer 3120.

The water content of dried aluminum leach residue 3121 may be less than approximately 1 wt. %, based on the total weight of dried aluminum leach residue 3121. For example, the water content of dried aluminum leach residue 3121 may be approximately 0.1% to approximately 25% of the water content of aluminum leach residue 3111.

Dried aluminum leach residue 3121 may include a solid phase, an aqueous phase, or both. Dried aluminum leach residue may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), zirconyl oxalate (ZrOC₂O₄), or a combination thereof.

Aluminum leach residue drying off-gas 3123 may include a solid phase, a gaseous phase, or both. The solid phase of aluminum leach residue drying off-gas 3123 may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), or a combination thereof. The gaseous phase of aluminum leach residue drying off-gas 3123 may comprise water (H₂O), argon (Ar), carbon dioxide (CO₂), nitrogen (N₂), oxygen (O₂), or a combination thereof.

Aluminum leach residue drying off-gas 3123 may be passed to a third off-gas scrubber 3008. Third off-gas scrubber 3008 may be configured to remove particulates from aluminum leach residue drying off-gas 3123. For example, third off-gas scrubber 3008 may be a venturi scrubber configured to receive a liquid phase (e.g., water 900) and aluminum leach residue drying off-gas 3123. The liquid phase may trap particulates from aluminum leach residue drying off-gas 3123, generating third off-gas scrubber effluent 3125. Off-gas from third off-gas scrubber 3008 may be passed to stack 850.

Third off-gas scrubber effluent 2125 may include a solid phase, an aqueous phase, or both. The solid phase of third off-gas scrubber effluent 2125 may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of third off-gas scrubber effluent 2125 may comprise ammonium hydroxide (NH₄OH), water (H₂O), oxalic acid (C₂H₂O₄), scandium oxalate (Sc₂(C₂O₄)₃), sodium chromate (Na₂CrO₄), vanadic acid (H₃VO₄), zirconium dioxide (ZrO₂), zirconyl hydroxide (ZrO(OH)₂), or a combination thereof.

Dried aluminum leach residue 3121 may be passed to a briquette mixer 3130. Briquette mixer 3130 may be configured to receive dried aluminum leach residue 3121 and one or more briquette additives 962. Briquette additives 962 may include one or more materials that facilitate the reductive roasting of metals within dried aluminum leach residue 3121. For example, briquette additives 962 may include fuel coke. Briquette mixer 3130 may combine, blend, mix, and/or homogenize dried aluminum leach residue 3121 with briquette additives 962. In embodiments where briquette additives 962 include fuel coke, the coke may be ground to an average particle size of less than or equal to approximately 250 μm, such as, for example, less than or equal to approximately 200 μm, less than or equal to approximately 100 μm, less than or equal to approximately 50 μm, approximately 25 to approximately 250 μm, approximately 25 μm to 50 μm, or approximately 40 μm to 50 μm.

The combined dried aluminum leach residue 3121 with briquette additives 962 may be passed to a briquetter 3132. Briquetter 3132 may form briquettes 3131 comprising the material from dried aluminum leach residue 3121 and one or more briquette additives 962.

Briquettes 3131 may include a solid phase, an aqueous phase, or both. The solid phase of briquettes 3131 may comprise aluminum hydroxide (Al(OH)₃), aluminum hydroxide oxide (AlO(OH)), calcium aluminosilicate (Ca₂Al₂SiO₇), calcium carbonate (CaCO₃), calcium hydroxide (Ca(OH)₂), calcium hydroxyphosphate (Ca₅(OH)(PO₄)₃), calcium iron oxide (CaO·Fe₂O₃), calcium pyrophosphate (Ca₂P₂O₇), calcium orthosilicate (Ca₂SiO₄), calcium sulfate (CaSO₄), calcium sulfate dihydrate (CaSO₄·2H₂O), carbon (C), cerium oxide (CeO₂), disodium phosphate (Na₂HPO₄), ferric oxide (Fe₂O₃), ferric oxyhydroxide (FeO(OH)), iron (Fe), iron (II, III) oxide (Fe₃O₄), iron phosphide (FeP), lanthanum (III) oxide (La₂O₃), lead (II) oxide (PbO), magnesium hydroxide (Mg(OH)₂), magnesium oxide (MgO), manganese (II) hydroxide (Mn(OH)₂), manganese oxide (MnO), neodymium (III) oxide (Nd₂O₃), nickel (II) oxide (NiO), niobium pentoxide (Nb₂O₅), one or more sodium/calcium aluminates (e.g., Na₂CaAl₄O₈), potassium oxide (K₂O), scandium oxalate (Sc₂(C₂O₄)₃), scandium oxide (Sc₂O₃), silicon dioxide (SiO₂), sodium carbonate (Na₂CO₃), sodium hydroxide (NaOH), sodium iron oxide (NaFeO₂), sodium metasilicate (Na₂SiO₃), sodium oxide (Na₂O), sodium phosphate (Na₃PO₄), strontium oxide (SrO), sulfur (S₈), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of briquettes 3131 may comprise water (H₂O), oxalic acid (C₂H₂O₄), vanadic acid (H₃VO₄), sodium dihydrogen arsenite (NaH₂AsO₃), sodium chromate (Na₂CrO₄), ammonium hydroxide (NH₄OH), scandium oxalate (Sc₂(C₂O₄)₃), zirconyl oxalate (ZrOC₂O₄), zirconyl hydroxide (ZrO(OH)₂), or a combination thereof.

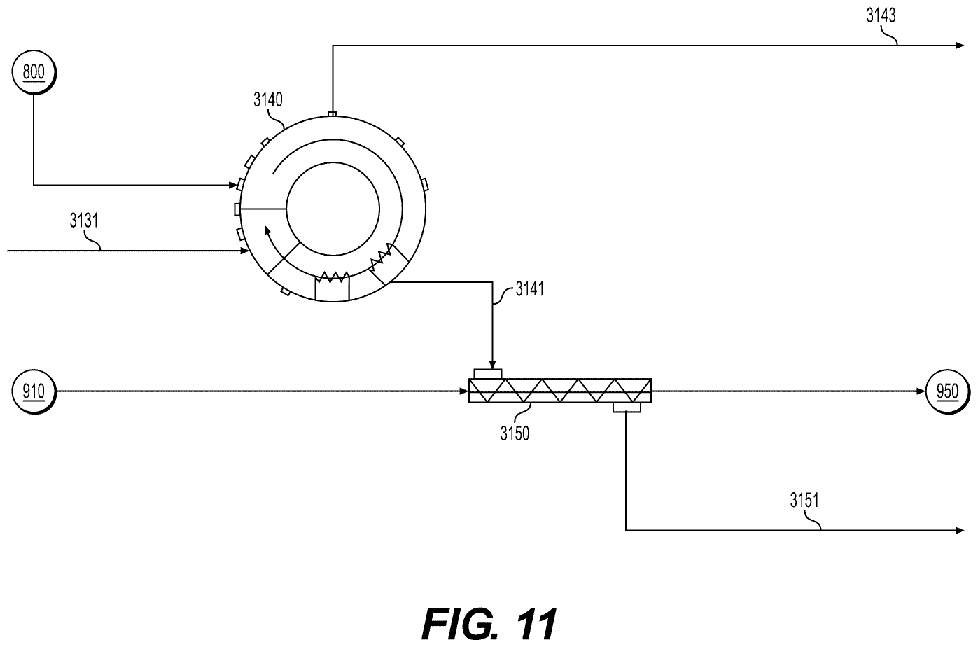

Referring to FIG. 11, in some embodiments, a system for beneficiating bauxite residue 100 may include a reduction roasting furnace 3140. Briquettes 3131 may be passed to a reduction roasting furnace 3140. In some embodiments, reduction roasting furnace 3140 may include a rotary hearth furnace. Reduction roasting furnace 3140 may be configured to receive briquettes 3131. In some embodiments, reduction roasting furnace 3140 is operably configured to receive air 800 such that an intake for air 800 may be configured to have an open position and a closed position.

Reduction roasting furnace 3140 may be configured to facilitate the roasting of briquettes 3131 to generate metallized briquettes 3141. For example, briquettes 3131 may be roasted at a temperature greater than or equal to approximately 1200° C. to generate metallized briquettes 3141. Reduction roasting off-gas 3143 may be generated during the roasting of briquettes 3131. During the roasting of briquettes 3131, some, most, or all aqueous water present in briquettes 3131 may convert to gaseous water. In addition or alternatively, one or more of the reactions listed in Table 4 may occur within reduction roasting furnace 3140.

Metallized briquettes 3141 may include a solid phase, an aqueous phase, or both. The solid phase of metallized briquettes 3141 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of metallized briquettes may include oxalic acid (C₂H₂O₄), sodium chromate (Na₂CrO₄), ammonium hydroxide (NH₄OH), zirconyl hydroxide (ZrO(OH)₂), or a combination thereof. In some embodiments, metallized briquettes 3141 do not include any water in an aqueous phase. Metallized briquettes 3141 may be passed to a briquette cooler 3150.

Reduction roasting off-gas 3143 may include a solid phase, a gaseous phase, or both. The solid phase of reduction roasting off-gas 3143 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The gaseous phase of reduction roasting off-gas 3143 may comprise water (H₂O), argon (Ar), carbon monoxide (CO), carbon dioxide (CO₂), nitrogen (N₂), oxygen (O₂), sulfur dioxide (SO₂), or a combination thereof.

In some embodiments, a system for beneficiating bauxite residue 100 may include a briquette cooler 3150. Briquette cooler 3150 may be configured to facilitate cooling of metallized briquettes 3141. In some embodiments, briquette cooler 3150 is configured to receive cooling water 910. Cooling water 910 may absorb heat from metallized briquettes 3141. After being passed through briquette cooler 3150, cooling water 910 may be passed to cooling tower 950. After metallized briquettes 3141 are cooled, the cooled briquettes 3151 may be passed from briquette cooler 3150 (e.g., to a briquette grinder 3160).

Cooled briquettes may include a solid phase, an aqueous phase, or both. The solid phase of cooled briquettes 3151 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of cooled briquettes 3151 may include oxalic acid (C₂H₂O₄), sodium chromate (Na₂CrO₄), ammonium hydroxide (NH₄OH), zirconyl hydroxide (ZrO(OH)₂), or a combination thereof.

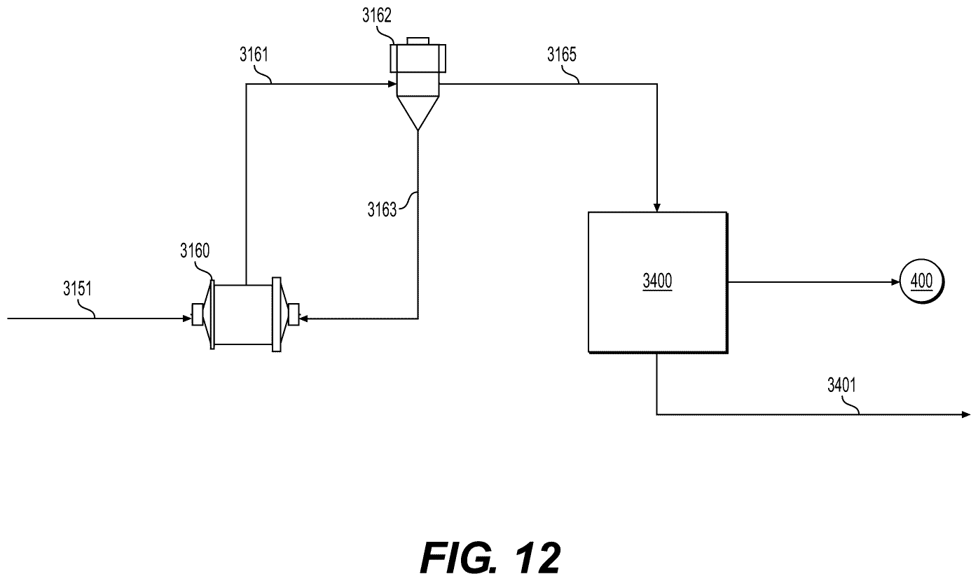

Referring to FIG. 12, a system for beneficiating bauxite residue 100 may include a briquette grinder 3160. Briquette grinder 3160 may be configured to receive cooled briquettes 3151, a high density stream 3163, or both. Briquette grinder 3160 may grind cooled briquettes 3151 to generate ground briquettes 3161.

Ground briquettes 3161 may include a solid phase, an aqueous phase, or both. The solid phase of ground briquette 3161 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of ground briquettes 3161 may comprise oxalic acid (C₂H₂O₄), sodium chromate (Na₂CrO₄), ammonium hydroxide (NH₄OH), zirconyl hydroxide (ZrO(OH)₂), or a combination thereof. Ground briquettes 3161 may be passed to an air classifier 3162.

Air classifier 3162 may separate ground briquettes 3161 into the high density stream 3163 and a low density stream 3165. The high density stream 3163 may be passed to briquette grinder 3160 for further grinding. The low density stream 3165 may be passed to a magnetic separator 3400.

High density stream 3163 may include a solid phase, an aqueous phase, or both. The solid phase of high density stream 3163 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of high density stream 3163 may comprise ammonium hydroxide (NH₄OH), scandium oxalate (Sc₂(C₂O₄)₃), sodium chromate (Na₂CrO₄), oxalic acid (C₂H₂O₄), sodium chromate (Na₂CrO₄), zirconyl hydroxide (ZrO(OH)₂), or a combination thereof.

Low density stream 3165 may include a solid phase, an aqueous phase, or both. The solid phase of low density stream 3165 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), or a combination thereof. The aqueous phase of low density stream 3165 may comprise ammonium hydroxide (NH₄OH), scandium oxalate (Sc₂(C₂O₄)₃), sodium chromate (Na₂CrO₄), oxalic acid (C₂H₂O₄), sodium chromate (Na₂CrO₄), zirconyl hydroxide (ZrO(OH)₂), or a combination thereof.

The magnetic separator 3400 may be configured to remove iron-containing species from low density stream 3165 to generate iron-rich stream 400. Slag residue 3401 may include material remaining from magnetic separation of ground briquettes 3161, and may be passed from magnetic separator 3400. Slag residue 3401 may include a solid phase, an aqueous phase, or both. The solid phase of slag residue 3401 may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium oxide (CaO), carbon (C), cerium oxide (CeO₂), iron (Fe), iron phosphide (FeP), lanthanum (III) oxide (La₂O₃), lead (II) oxide (PbO), magnesium oxide (MgO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of slag residue 3401 may comprise water (H₂O), oxalic acid (C₂H₂O₄), sodium chromate (Na₂CrO₄), ammonium hydroxide (NH₄OH), zirconyl hydroxide (ZrO(OH)₂), or a combination thereof. In some embodiments, slag residue 3401 may be passed to a scandium precipitation tank 3500.

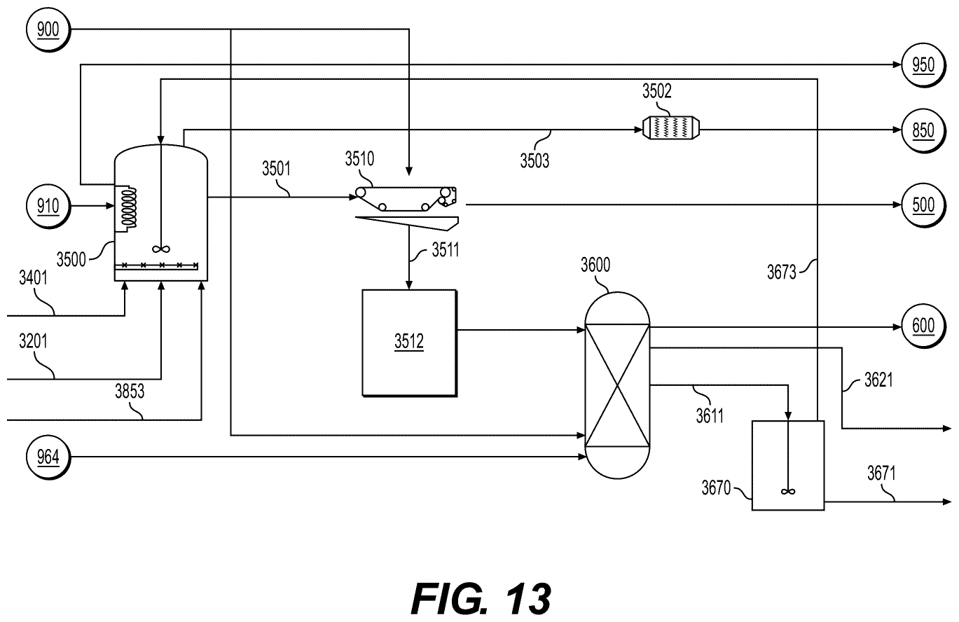

Referring to FIG. 13, a system for beneficiating bauxite residue 100 may include a scandium precipitation tank 3500. Scandium precipitation tank 3500 may be configured to receive slag residue 3401, purified aluminum leachate 3201, a depleted scandium ion exchange solution 3673, or a combination thereof. In addition or alternatively, scandium precipitation tank 3500 may be configured to receive one or more off-gas streams generated by one or more other components of the system for beneficiating bauxite residue 100 (e.g., second portion 3853 of sulfur dioxide scrubber effluent). In some embodiments, the one or more off-gas streams generated by one or more other components of the system may be bubbled through a solution including slag residue 3401 and purified aluminum leachate 3201, to generate scandium precipitate 3501. For example, one or more of the reactions listed in Table 5 may occur within scandium precipitation tank 3500. Scandium precipitation tank 3500 may be configured to receive cooling water 910 to promote and/or enhance formation of scandium precipitate 3501. After being passed through scandium precipitation tank 3500, cooling water 910 may be returned to cooling tower 950. The formation of scandium precipitate 3501 from slag residue 3401, and/or the bubbling of one or more off-gases within scandium precipitation tank 3500, may generate scandium precipitation off-gas 3503.

Scandium precipitation off-gas 3503 may include a gaseous phase comprising water (H₂O), argon (Ar), carbon dioxide (CO₂), nitrogen (N₂), oxygen (O₂), or a combination thereof. Scandium precipitation off-gas 3503 may be passed through a scandium precipitation demister 3502, before being passed to stack 850. Demister 3502 may remove liquid droplets and/or entrained liquids from scandium precipitation off-gas 3503.

Scandium precipitate 3501 may include a solid phase, an aqueous phase, or both. The solid phase of scandium precipitate 3501 may comprise may comprise arsenic trioxide (As₂O₃), calcium aluminosilicate (Ca₂Al₂SiO₇), calcium hydroxide (Ca(OH)₂), calcium hydroxyphosphate (Ca₅(OH)(PO₄)₃), calcium orthosilicate (Ca₂SiO₄), calcium sulfate dihydrate (CaSO₄·2H₂O), calcium magnesium carbonate (CaMg(CO₃)₂), calcium carbonate (CaCO₃), manganese carbonate (MnCO₃), carbon (C), cerium oxide (CeO₂), iron (Fe), iron phosphide (FeP), lanthanum (III) oxide (La₂O₃), lead (II) oxide (PbO), manganese oxide (MnO), neodymium (III) oxide (Nd₂O₃), nickel (II) oxide (NiO), niobium pentoxide (Nb₂O₅), potassium oxide (K₂O), scandium oxalate (Sc₂(C₂O₄)₃), scandium oxide (Sc₂O₃), sodium carbonate (Na₂CO₃), sodium hydroxide (NaOH), strontium oxide (SrO), thorium dioxide (ThO₂), titanium dioxide (TiO₂), vanadium pentoxide (V₂O₅), yttrium (III) oxide (Y₂O₃), zirconium dioxide (ZrO₂), ammonium hydroxide (NH₄OH), scandium oxalate (Sc₂(C₂O₄)₃), sodium chromate (Na₂CrO₄), zirconium dioxide (ZrO₂), or a combination thereof. The aqueous phase of scandium precipitate 3501 may comprise oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof. Scandium precipitate 3501 may be passed to a scandium precipitation filter 3510.

Scandium precipitation filter 3510 may separate a residue and a scandium precipitation filtrate 3511 from scandium precipitate 3501. The residue may be further processed and/or removed, to form calcium/silicon/titanium-rich stream 500. Portions of the residue that do not form calcium/silicon/titanium-rich stream 500 may be incorporated into aggregate or other components of building materials.

Scandium precipitation filtrate 3511 may include an aqueous phase comprising water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof. Scandium precipitation filtrate 3511 may be passed to a scandium ion exchange feed tank 3512.

Scandium ion exchange feed tank 3512 may be configured to monitor, control, and/or adjust a stream of scandium precipitation filtrate 3511 to a scandium ion exchange tank 3600. Scandium ion exchange tank 3600 may be configured to receive scandium precipitation filtrate 3511, water 900, one or more scandium-zirconium ion exchange solutions 964, or a combination thereof. In some embodiments, scandium-zirconium ion exchange solutions 964 include an organic acid, such as, for example, oxalic acid (C₂H₂O₄). Scandium ion exchange tank 3600 may facilitate one or more ion exchange reactions. For example, one or more of the reactions listed in Table 6 may occur within scandium ion exchange tank 3600. During or after the one or more ion exchange reactions, a scandium-rich stream 600, scandium ion exchange wash waste 3621, and/or scandium precipitation liquor 3611, may passed from scandium ion exchange tank 3600.

Scandium ion exchange wash waste 3621 may include an aqueous phase comprising water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof. Scandium ion exchange wash waste 3621 may be passed to aluminum leach tank 3100.

Scandium precipitation liquor 3611 may include an aqueous phase comprising water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof. Scandium precipitation liquor 3611 may be passed to a depleted solution tank 3670. Depleted solution tank 3670 may collect, retain, and/or store scandium precipitation liquor 3611. Depleted scandium ion exchange solution 3673 may be passed from depleted solution tank 3670 to scandium precipitation tank 3500. In addition or alternatively, an impurity bleed 3671 may be passed from depleted solution tank 3670 to sodium carbonate evaporator feed tank 3322. In some embodiments, depleted solution tank 3670 may monitor, control, and/or adjust the stream of depleted scandium ion exchange solution 3673 to scandium precipitation tank 3500. In addition or alternatively, depleted solution tank 3670 may monitor, control, and/or adjust the stream of impurity bleed 3671 to sodium carbonate evaporator feed tank 3322.

Depleted scandium ion exchange solution 3673 may include an aqueous phase comprising water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof. Impurity bleed 3671 may include an aqueous phase comprising water (H₂O), oxalic acid (C₂H₂O₄), sodium chromate (Na₂CrO₄), sodium carbonate (Na₂CO₃), sodium bicarbonate (NaHCO₃), scandium carbonate (Sc₂(CO₃)₃), scandium oxalate (Sc₂(C₂O₄)₃), zirconyl oxalate (ZrO(C₂O₄)), ammonium hydroxide (NH₄OH), zirconyl hydroxide (ZrO(OH)₂), or a combination thereof.

Multiple examples of systems and methods for beneficiating bauxite residue 100 have been described herein. Characteristics, aspects, components, or steps of any one method or system may be applied to any other method or system described herein.

### EXAMPLES

The following examples are intended to illustrate the present disclosure without being limiting in nature. It is understood that the present disclosure encompasses additional aspects and embodiments consistent with the foregoing description and following examples.

### Example 1

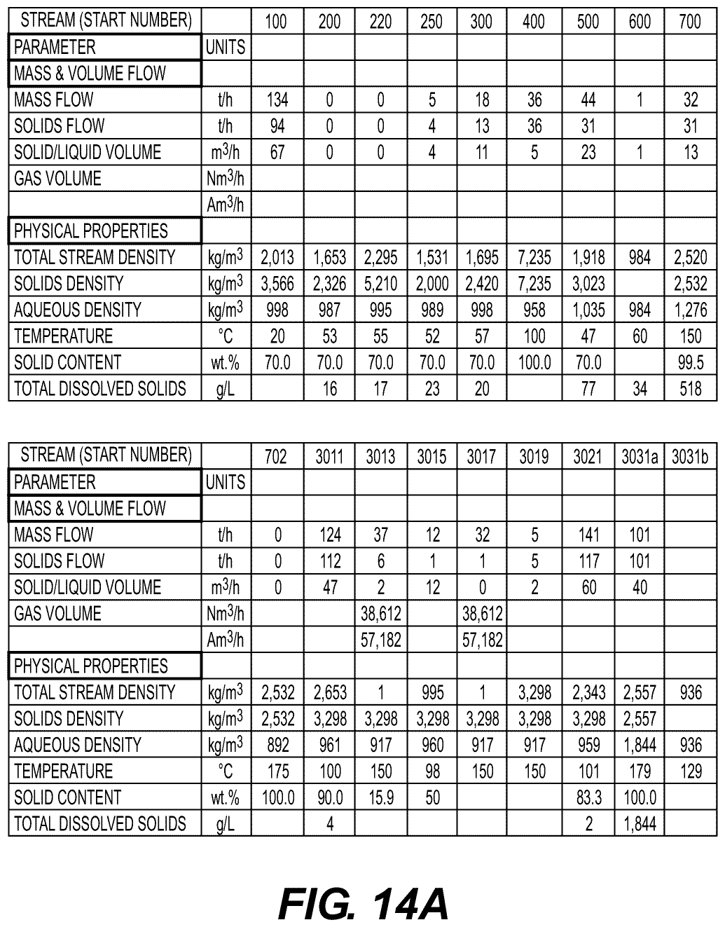

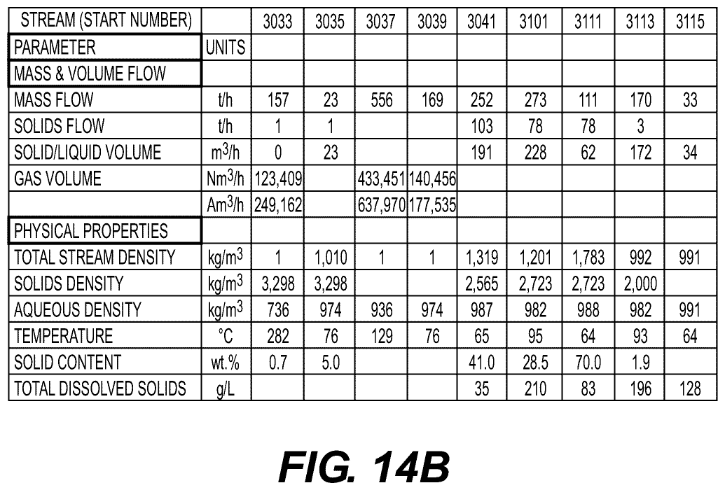

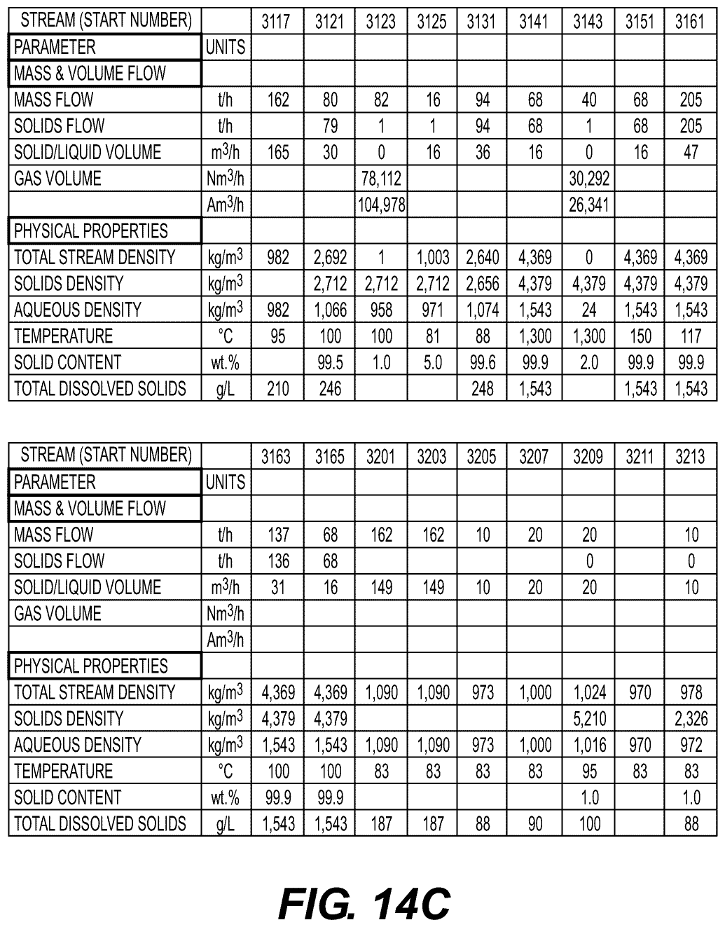

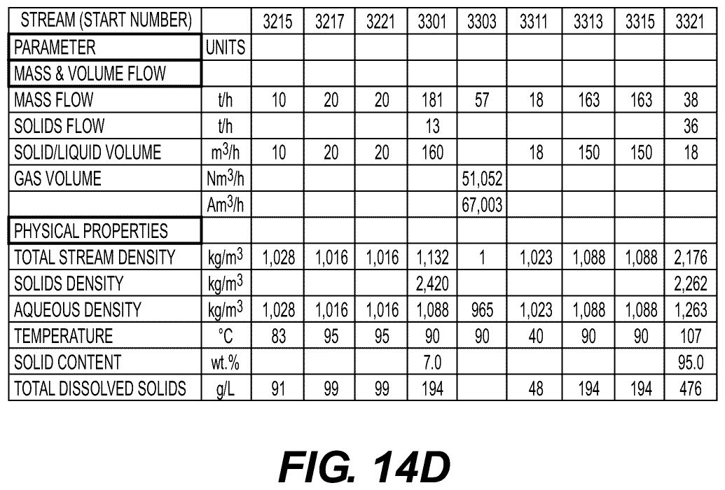

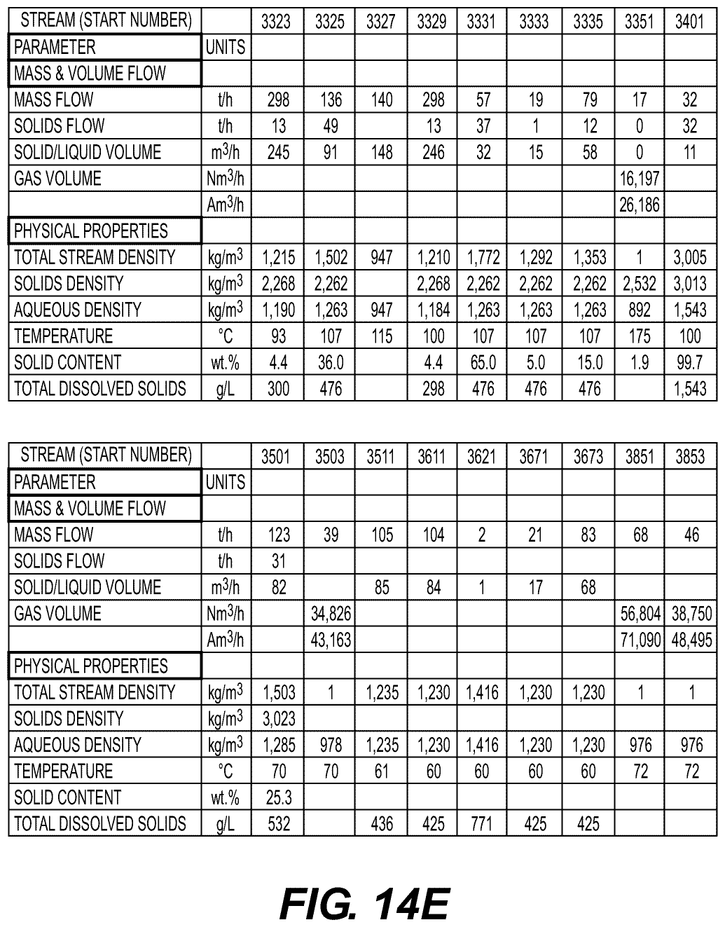

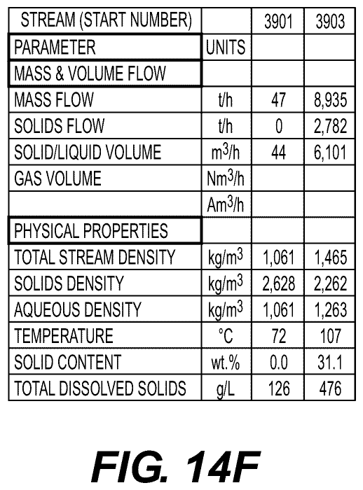

A system for beneficiating bauxite residue was designed and implemented according to aspects of the present disclosure. Bauxite residue was beneficiated using the system, according to aspects of the present disclosure. The mass flow, solids flow, solid and liquid volume flow, gas volume flow, total stream density, solids density, aqueous density, temperature, solids content, and total dissolved solids of each stream were calculated and are summarized in FIGS. 14A-14F. Streams in FIGS. 14A-14F are identified by the part number, as described above. The total mass flow and solids flow of each stream are shown in tons per hour. The solid and liquid volume flow is shown in cubic meters per hour. The gas volume flow is shown in normal cubic meters per hour and actual cubic meters per hour. The total stream density, solids density, and aqueous density are shown in kilograms per cubic meter. The temperature of each stream is shown in degrees Celsius. The solids content is shown in wt. %, based on the total weight of the stream. The total dissolved solids are shown in grams per liter.

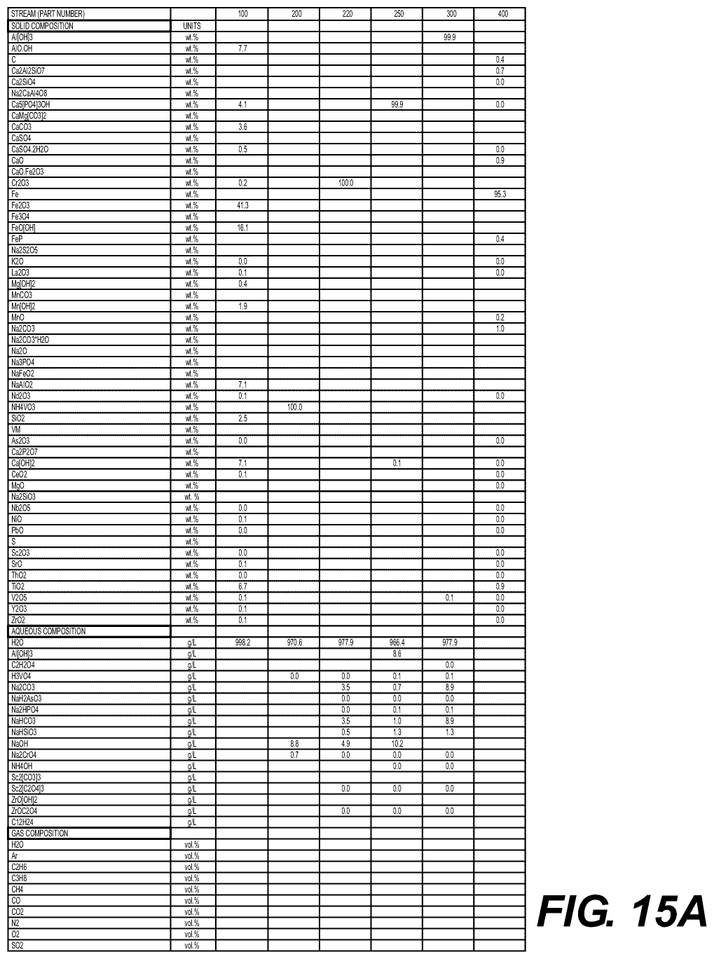

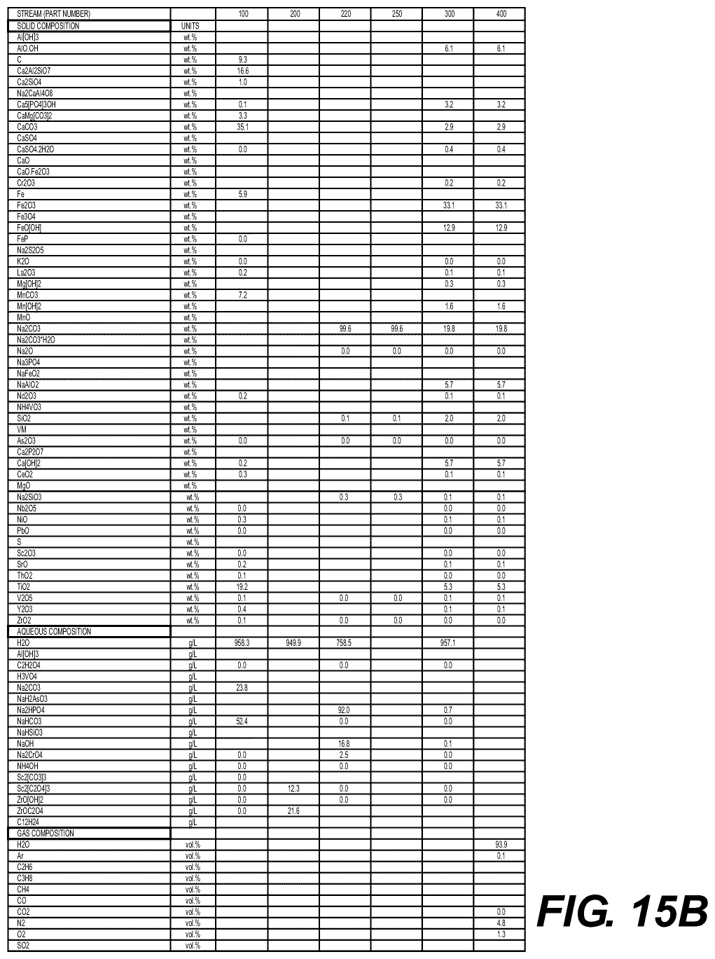

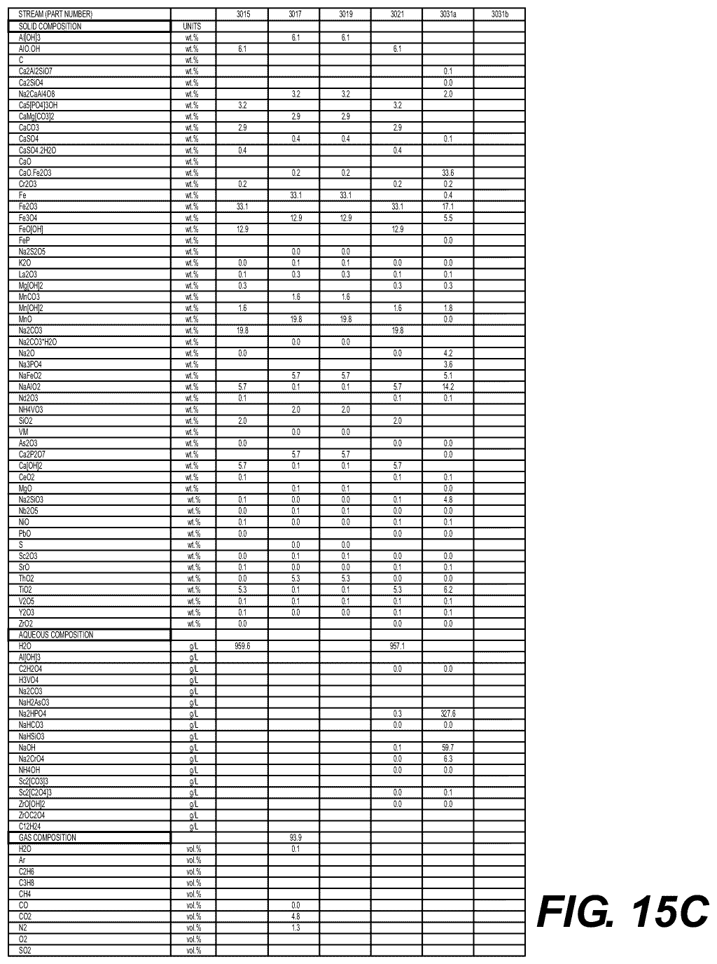

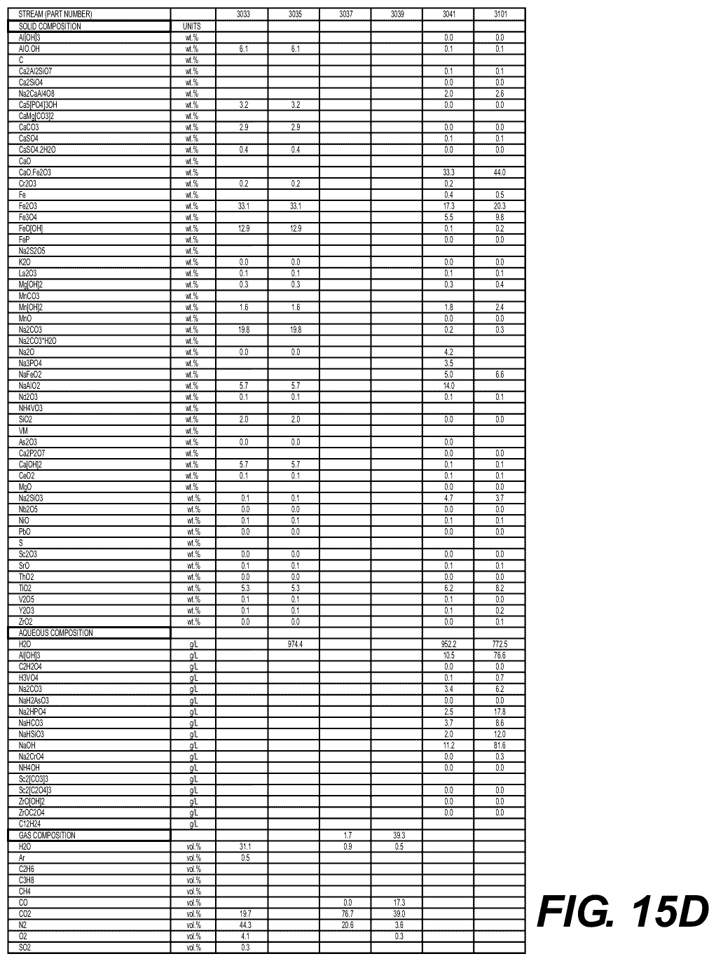

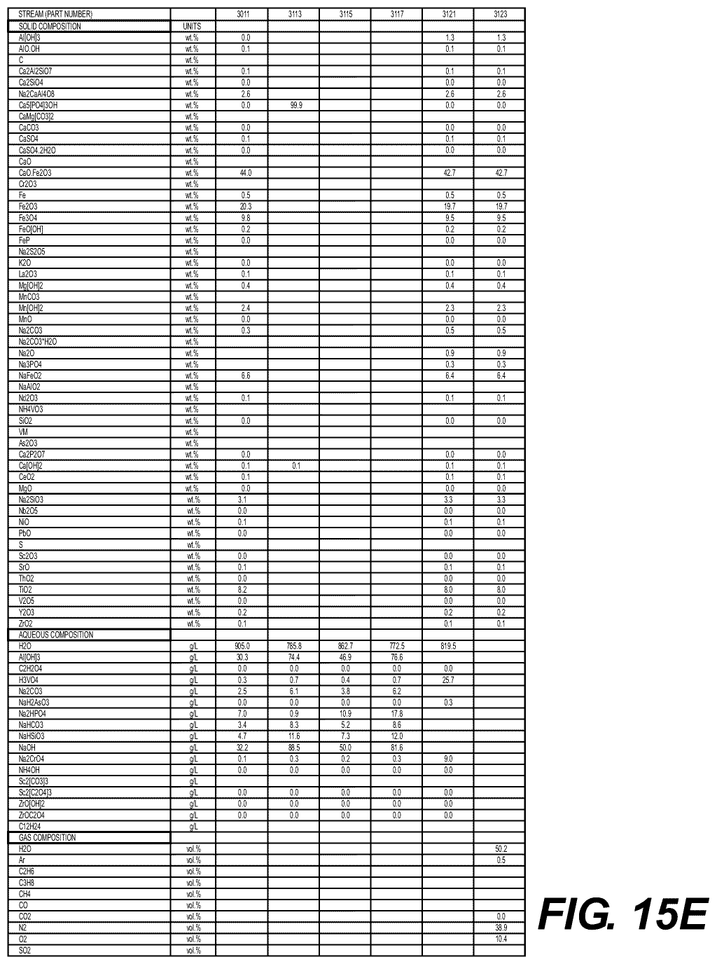

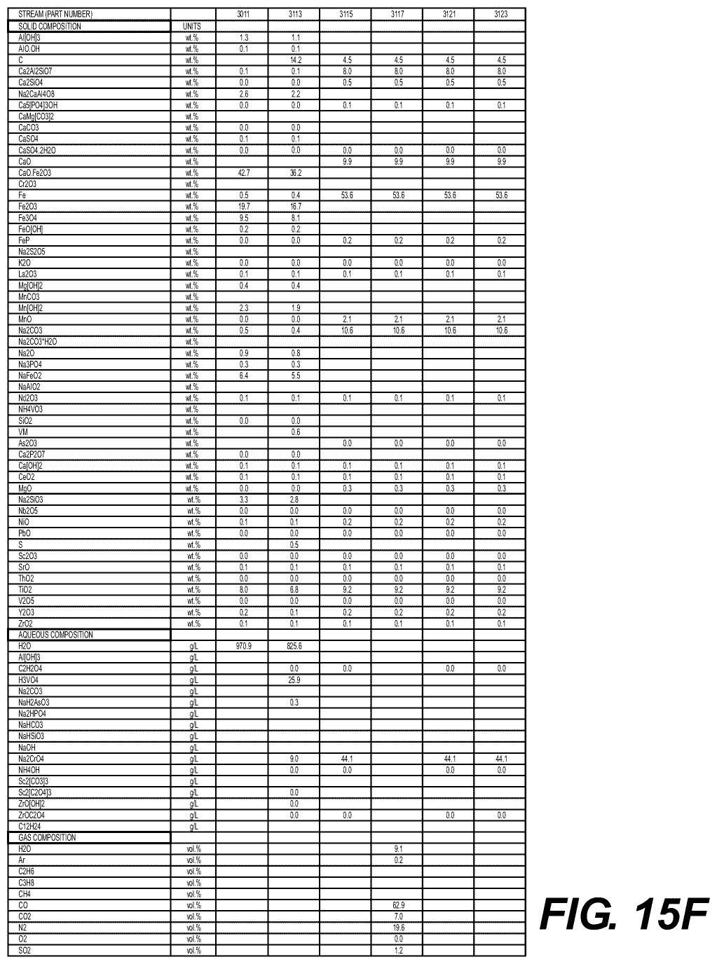

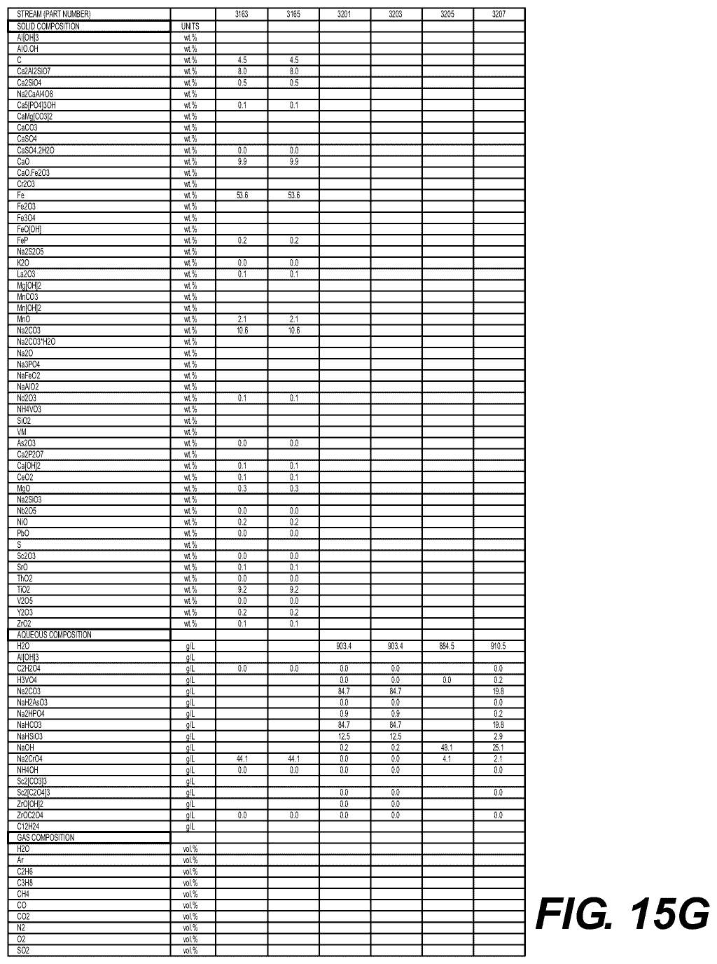

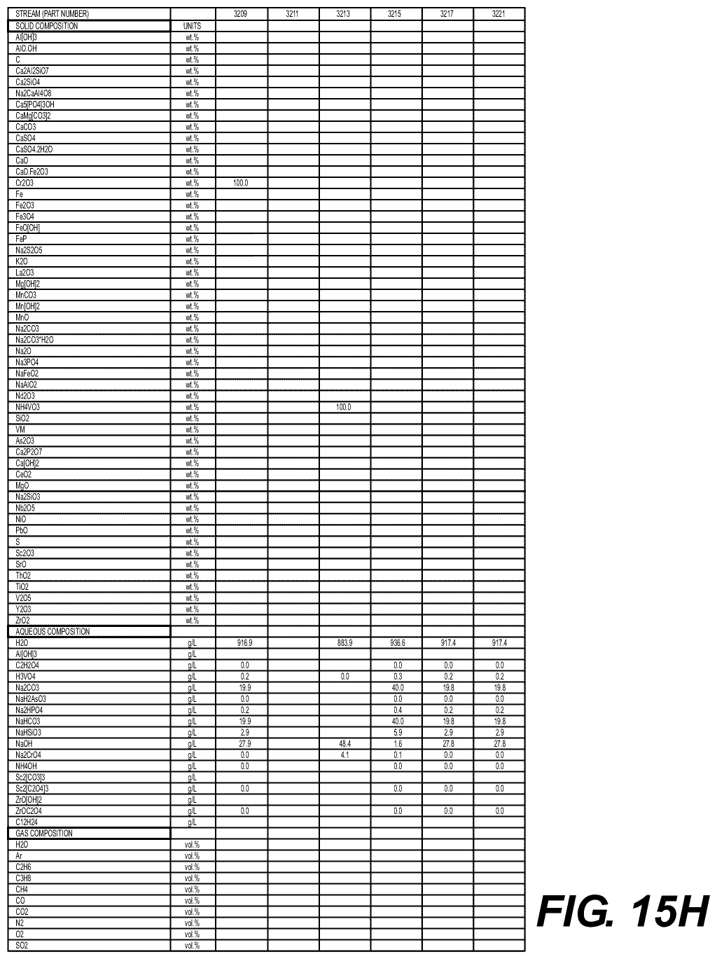

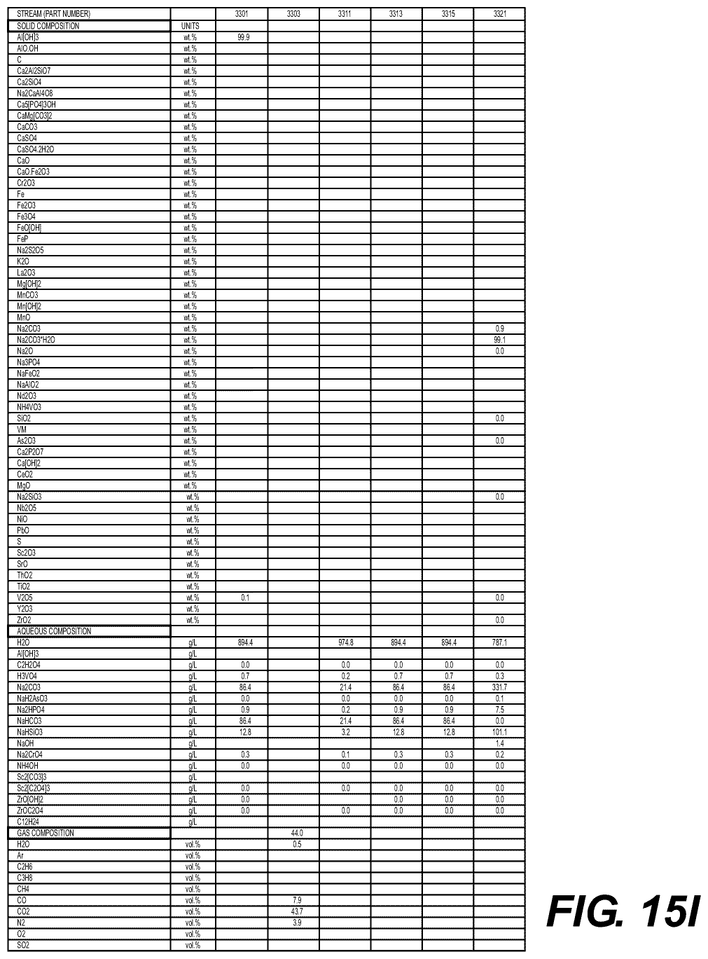

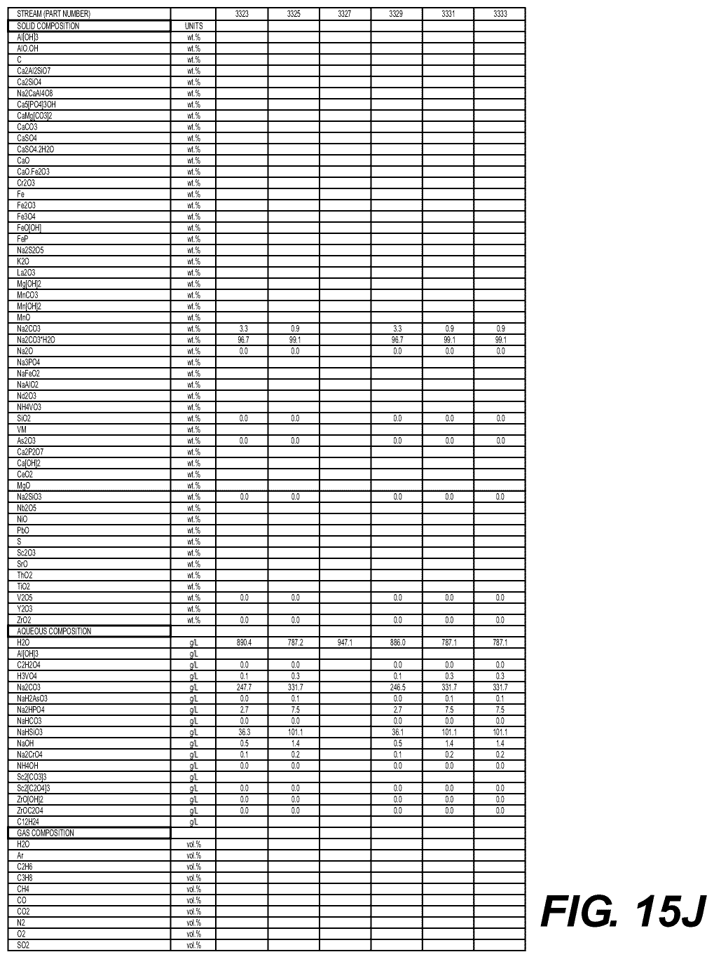

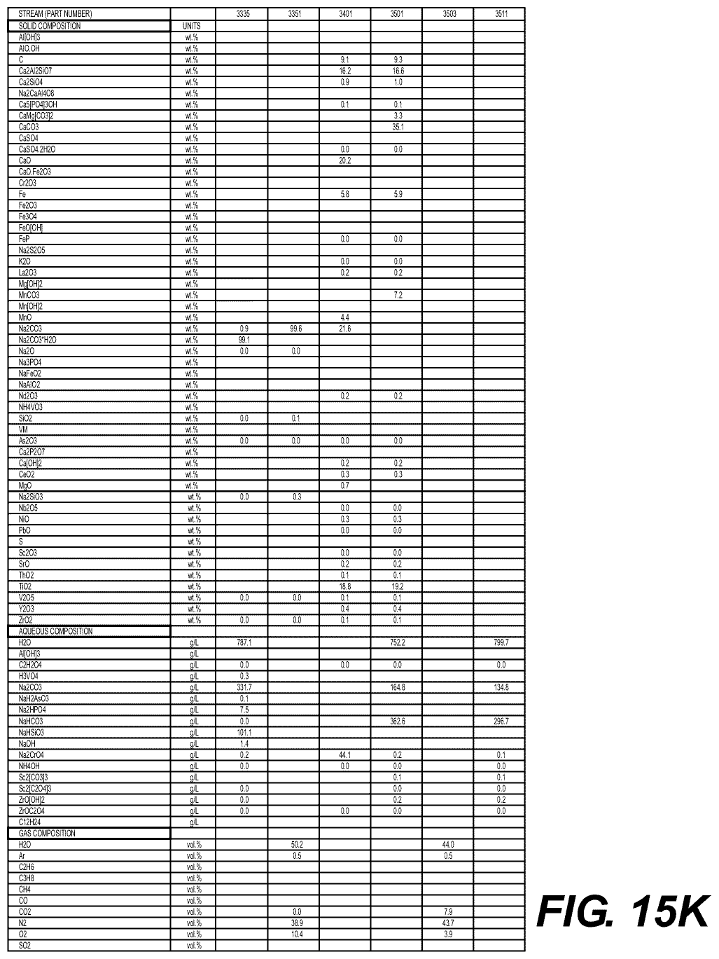

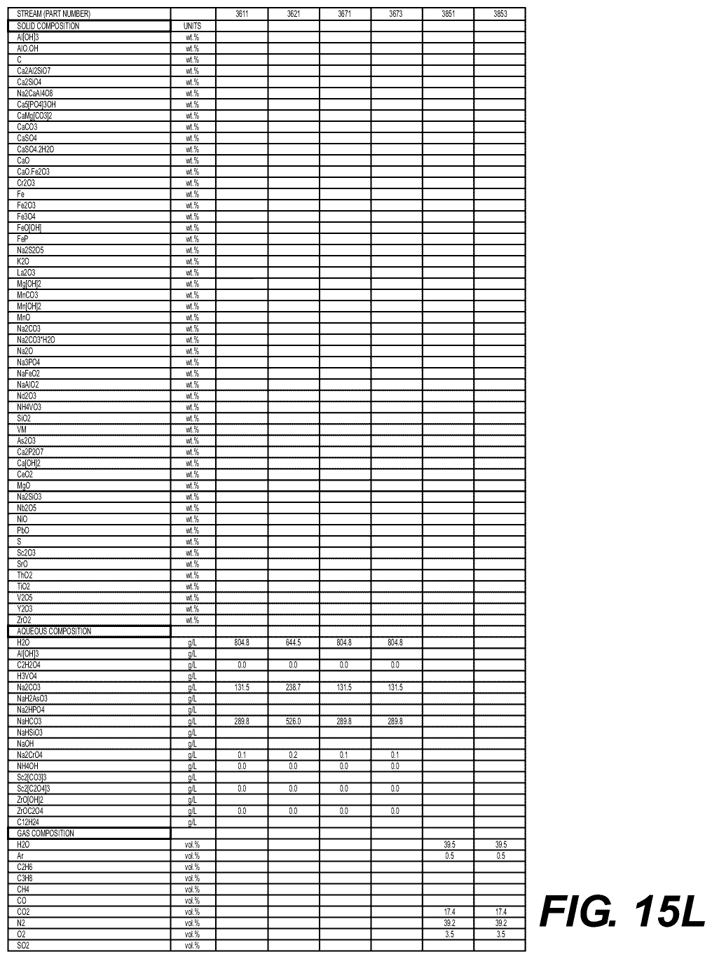

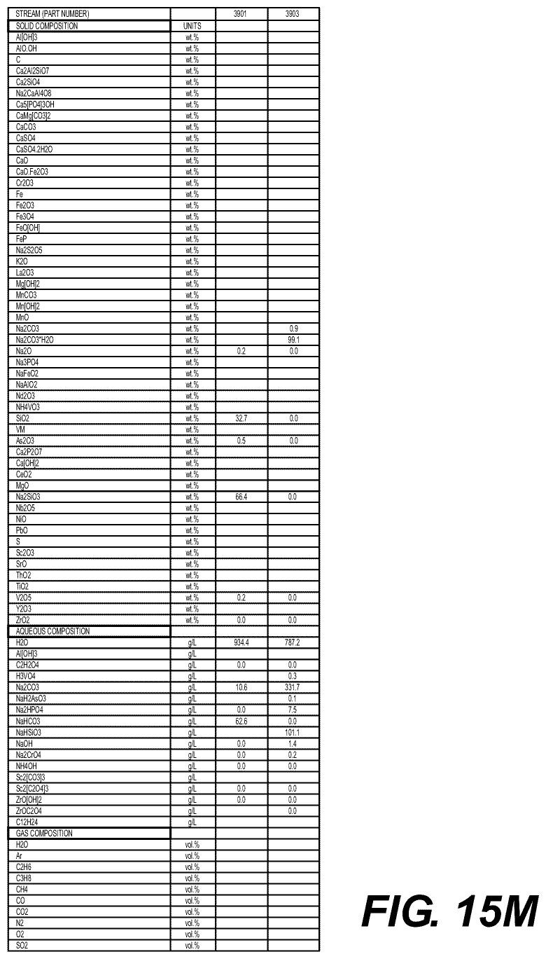

An exemplary composition for each stream detailed in FIGS. 14A-14F is shown in FIGS. 15A-15M. Streams in FIGS. 15A-15M are identified by the part number, as described above. The solids composition of each stream including a solid phase is shown in wt. %, based on the total weight of solids in the stream. The aqueous composition of each stream including an aqueous phase is shown as the concentration of the aqueous component within the stream, in grams per liter. The gaseous composition of each stream include a gaseous phase is shown in volume percent (vol. %), based on the total volume of the gaseous phase.

### Example 2

Mass and energy summaries for an exemplary process for beneficiating bauxite residue are described in Tables 10 and 11. Table 11 includes a list of exemplary mass flows input into a system for beneficiating bauxite residue including bauxite residue and other reagents. Table 11 also lists the emissions and product mass flows that would be generated based on the listed input mass flows. The mass flows shown in Table 11 are calculated in tons per hour (t/h), tons of carbon dioxide per hour (tCO₂/h), or kilograms per hour (kg/h).

TABLE 11
Exemplary Mass Flows

| | |
|---|---|
| MATERIAL | MASS FLOW |

System Inputs

| | | |
|---|---|---|
| bauxite residue (dry solids) | 94.0 | (t/h) |
| bauxite residue (total mass) | 134.3 | (t/h) |
| sodium hydroxide | 8.84 | (t/h) |
| calcium hydroxide | 2.44 | (t/h) |
| coke fuel | 14.4 | (t/h) |
| ammonium hydroxide | 0.028 | (t/h) |
| sodium metabisulfite | 0.36 | (t/h) |
| oxalic acid | 0.019 | (t/h) |
| cooling water | 3126 | (t/h) |
| process water | 213.3 | (t/h) |

Emissions

| | | |
|---|---|---|
| off-gas from aluminum precipitation | 7.83 | (tCO₂/h) |
| off-gas from scandium precipitation | 5.34 | (tCO₂/h) |
| off-gas not used for carbonization | 15.0 | (tCO₂/h) |
| waste water | 67.9 | (t/h) |

Products

| | | |
|---|---|---|
| excess sodium carbonate | 4.03 | (t/h) |
| condensate from sodium carbonate evaporator | 140 | (t/h) |
| aluminum hydroxide | 12.6 | (t/h) |
| pig iron | 36.5 | (t/h) |
| titanium/silicon/calcium-rich solids | 31.0 | (t/h) |
| calcium hydroxyphosphate | 3.30 | (t/h) |
| ammonium metavanadate | 94.8 | (kg/h) |
| chromium oxide | 192 | (kg/h) |
| scandium | 2.99 | (kg/h) |
| zirconium | 9.64 | (kg/h) |

Table 12 lists a summary of an exemplary energy expenditure required by components of a system for beneficiating bauxite residue, to process the mass flows listed in Table 11.

TABLE 12
Exemplary Energy Requirements

| Component | Electricity Required (kilowatt · hours) |
|---|---|
| reduction roasting furnace | 83,309 |
| sodium carbonate evaporator | 6,434 |
| sodium carbonate paddle dryer | 24,894 |
| bauxite residue paddle dryer | 25,840 |
| aluminum leach residue dryer | 7,054 |

The above description and examples are illustrative, and not intended to be restrictive. For example, and as has been described, the above-described embodiments (and/or aspects thereof) may be used in combination with each other.

What is claimed is:

1. A system for beneficiating bauxite residue, the system comprising:
a first reaction vessel configured to receive a first stream comprising vanadic acid (H₃VO₄) and a second stream comprising an alkaline solution;
a third stream passed from the first reaction vessel, wherein the third stream comprises a metavanadate salt;
a filter configured to separate a vanadium-rich stream from the third stream;
a second reaction vessel configured to receive a fourth stream comprising scandium carbonate (Sc₂(CO₃)₃) and a fifth stream comprising an organic acid;
a fifth stream passed from the second reaction vessel, wherein the fifth stream comprises at least approximately 0.1 wt. % of a salt comprising scandium, based on the total weight of the fifth stream.

2. The system of claim 1, wherein the first stream is derived from bauxite residue.

3. The system of claim 2, wherein the fourth stream is derived from bauxite residue.

4. The system of claim 1, wherein the vanadium-rich stream comprises at least approximately 95 wt. % of the metavanadate salt, based on the total weight of solids in the vanadium-rich stream.

5. The system of claim 1, wherein the metavanadate salt includes ammonium metavanadate (NH₄VO₃).

6. The system of claim 1, wherein the salt comprising scandium includes scandium oxalate (Sc₂(C₂O₄)₃).

7. The system of claim 1, wherein the fifth stream comprises at least approximately 1.0 wt. % of the salt comprising scandium.

8. The system of claim 1, wherein the filter is further configured to separate a sixth stream from the third stream, wherein the sixth stream comprises a chromate salt, and the system further comprises:
a third reaction vessel configured to receive the sixth stream and a seventh stream comprising a bisulfite salt; and
an eighth stream comprising chromium oxide (Cr₂O₃) passed from the third reaction vessel.

9. The system of claim 1, wherein the filter is a first filter, and the system further comprises:
a second filter configured to separate a titanium/calcium/silicon-rich stream and the fourth stream from a sixth stream, wherein the sixth stream comprises scandium carbonate (Sc₂(CO₃)₃), calcium carbonate (CaCO₃), one or more calcium aluminosilicates, and titanium dioxide (TiO₂).

10. A system for beneficiating bauxite residue, the system comprising:
a first reaction vessel configured to receive a first stream and an alkaline solution, wherein the first stream is derived from bauxite residue;
a first filter configured to separate a leach residue and a leach filtrate from a leachate passed from the first reaction vessel;
a second reaction vessel configured to roast a mixture including the leach residue, wherein roasting the mixture including the leach residue generates a metallized residue;
a third reaction vessel configured to receive a second stream and oxalic acid, wherein the second stream comprises at least a portion of the metallized residue; and
a third stream passed from the third reaction vessel, wherein the third stream comprises:
at least approximately 1.0 wt. % scandium oxalate (Sc₂(C₂O₄)₃), based on the total weight of the third stream;
at least approximately 1.0 wt. % zirconyl oxalate (ZrOC₂O₄), based on the total weight of the third stream; or
both.

11. The system of claim 10, wherein roasting the mixture including the leach residue also generates roasting off-gas, and the system further comprises a fourth reaction vessel configured to receive the roasting off-gas and a fourth stream comprising at least a portion of the leach filtrate.

12. The system of claim 11, further comprising a second filter configured to separate an aluminum-rich stream and a precipitate filtrate from an aluminum slurry passed from the fourth reaction vessel, wherein the aluminum-rich stream comprises at least 95 wt. % of an aluminum salt, based on the total weight of solids in the aluminum slurry.

13. The system of claim 12, further comprising an evaporator configured to remove water from a fifth stream, wherein the fifth stream includes at least a portion of the precipitate filtrate.

14. The system of claim 10, further comprising:
a fourth reaction vessel configured to receive a solution comprising calcium hydroxide and fourth stream comprising at least a portion of the leach filtrate;
a second filter configured to separate a phosphorous-containing compound and a purified filtrate from a fifth stream passed from the fourth reaction vessel.

15. The system of claim 14, further comprising:
a fifth reaction vessel configured to receive a solution comprising a hydroxide salt and fifth stream comprising at least a portion of the purified filtrate;
a third filter configured to separate a vanadium-rich stream from a sixth stream passed from the fifth reaction vessel.

16. The system of claim 15, wherein the vanadium-rich stream includes at least 95 wt. % of a compound comprising vanadium, based on the total weight of the vanadium-rich stream.

17. A method for beneficiating bauxite residue, the method comprising:
introducing bauxite residue and sodium carbonate (Na₂CO₃) to a dryer;
blending and drying the sodium carbonate (Na₂CO₃) and bauxite residue in the dryer, thereby forming dried bauxite residue;
introducing an alkaline solution and a stream including the dried bauxite residue to a first reaction vessel, and forming a leachate within the first reaction vessel;
separating a leach residue and a leach filtrate from the leachate;
precipitating a phosphorous-containing compound, a vanadium-containing compound, or both, out of the leach filtrate, thereby forming a purified leachate; and
precipitating a salt, out of the purified leachate, wherein the salt comprises aluminum.

18. The method of claim 17, wherein the phosphorous-containing compound is a hydroxyphosphate salt and the vanadium-containing compound is a metavanadate salt.

19. The method of claim 17, further comprising:
roasting the leach residue, to form a roasted leach residue and roasting off-gas;
magnetically separating iron-containing species from the roasted leach residue, thereby forming a slag residue;
introducing the slag residue the roasting-off gas to a second reaction vessel, and forming a precipitate in the second reaction vessel.

20. The method of claim 17, wherein the stream including the dried bauxite residue is a first stream, and the method further comprises:
introducing oxalic acid and a second stream to a second reaction vessel, wherein the second stream is derived from the leach residue; and
passing a third stream from the second reaction vessel, wherein the third stream comprises scandium oxalate (Sc₂(C₂O₄)₃) and zirconyl oxalate (ZrOC₂O₄).
